(19) United States
(12) Patent Application Publication
(10) Pub. No.: US 2010/0094649 A1
(43) Pub. Date: Apr. 15, 2010

(54) MEDICAL DATA AND MEDICAL INFORMATION SYSTEM INTEGRATION AND COMMUNICATION

(75) Inventor: Keith S. White, Salt Lake City, UT (US)

Correspondence Address: AUSTIN RAPP & HARDMAN, 170 South Main Street, Suite 735, SALT LAKE CITY, UT, 84101, US

(73) Assignee: IHC Intellectual Asset Management, LLC, Salt Lake City, UT (US)

(21) Appl. No.: 12/578,494

(22) Filed: Oct. 13, 2009

Related U.S. Application Data
(60) Provisional application No. 61/104,906, filed on Oct. 13, 2008.

(51) Int. Cl. G06Q 50/00; G06Q 10/00; G06F 17/30; G06F 21/00

(52) U.S. Cl. 705/2; 707/769; 707/803; 726/4; 707/E17.014; 707/E17.044; 707/E17.005

(57) ABSTRACT

A method for coding medical data is described. Medical data is obtained. A computing device determines whether the medical data in a case matches a code or a code mapping. A computing device codes the case if the medical data matches a code. Coding includes assigning a specific code to the case if the medical data matches the specific code. The computing device generates a bill for the case based on the specific code if the medical data matches the specific code.

### RELATED APPLICATIONS

This application is related to and claims priority from U.S. Provisional Patent Application Ser. No. 61/104,906 filed Oct. 13, 2008 for “Systems and Methods for Coding and Communication of Medical Records and Integrating Medical Information Systems,” which is incorporated herein by reference.

### TECHNICAL FIELD

The present disclosure relates generally to computers and computer-related technology. More specifically, the present disclosure relates to integrating medical information systems, coding medical data, and exchanging medical data.

### BACKGROUND

Computer and communication technologies continue to advance at a rapid pace. Indeed, computer and communication technologies are involved in many aspects of a person's day. Computers commonly used include everything from hand-held computing devices to large multi-processor computer systems.

Computer technology is becoming increasingly important in the medical services environment. For example, computers may be used to create patient records. Medical images may often be stored in a digital format. Also, several different computer systems may be used in the medical environment. For example, a Picture Archiving and Communication System (PACS) may be used to store images captured by a medical imaging device. Furthermore, a Hospital Information System (HIS) may be used for administrative functions in a hospital.

Medical personnel often find that computer systems lack desired functionality and integration. This may cause several problems, including an inability to quickly access comprehensive patient records or track treatment and procedure orders.

As shown from the above discussion, there is a need for systems and methods that will improve the functionality and integration of computer systems in the medical services environment. Thus, benefits may be realized by providing improved systems and methods for the communication and integration of medical records and medical information systems.

### BRIEF DESCRIPTION OF THE DRAWINGS

FIG. 1 is a block diagram illustrating one configuration of an integrator;

FIG. 2 is a block diagram illustrating another configuration of an integrator;

FIG. 3 is a flow diagram illustrating a method for integrating medical information systems;

FIG. 4 is a block diagram illustrating medical information system integration;

FIG. 5 is a flow diagram illustrating a method for determining an order status;

FIG. 6 is a flow diagram illustrating a method for workflow management;

FIG. 7 is a flow diagram illustrating one configuration of a method for dynamic data structure creation and data collection in a medical services environment;

FIG. 8 is a flow diagram illustrating one example of a method for dynamic data structure creation and data collection in a medical services environment;

FIG. 9 is a block diagram illustrating one configuration of an integrator user interface;

FIG. 10 is a block diagram illustrating one configuration of a coder system;

FIG. 11 is a block diagram illustrating another configuration of a coder system;

FIG. 12 is a block diagram illustrating one configuration of a coder;

FIG. 13 is a block diagram illustrating one configuration of a coder engine;

FIG. 14 is a flow diagram illustrating a method for coding medical data;

FIG. 15 is a block diagram illustrating a coder user interface;

FIG. 16 is a block diagram illustrating one configuration of an exchanger;

FIG. 17 is a block diagram illustrating one configuration of an exchanger and publishing system;

FIG. 18 is a block diagram illustrating one example of a security policy;

FIG. 19 is a flow diagram illustrating one method for publishing medical data;

FIG. 20 is a block diagram illustrating a user interface;

FIG. 21 is a block diagram illustrating a user interface; and

FIG. 22 illustrates various components that may be utilized in a medical information system, an integrator, a coder, an exchanger, and/or a publishing system.

### DETAILED DESCRIPTION

Computer technology is becoming increasingly important in the medical services environment. For example, computer systems may be used to create records when patients are admitted to medical facilities. One such computer system is known as the Hospital Information System (HIS). The HIS may include other subsystems. One example of such a subsystem may be a Radiology Information System (RIS). This system may be used to record information such as patient demographics, case history, or treatment orders. Other systems may independently create records when patients undergo image capturing procedures. For example, a Picture Archive Communication System (PACS) may be used to store images captured by an imaging device or modality along with patient information. Some of these imaging devices may include a Computed Tomography (CT) scanner, Magnetic Resonance Imaging (MRI) scanner, X-Ray machine, Ultrasound (US) machine, Positron Emission Tomography (PET) scanner, Computed Radiography (CR) scanner, Mammogram (MG) equipment and Digital Radiography (DR) equipment, amongst others.

One current challenge in the medical services environment may be a lack of integration between various computing devices. For example, the PACS and RIS may lack the functionality and integration necessary to automatically keep comprehensive records updated. This lack of functionality and integration may lead to several problems, including: an inability to quickly access comprehensive patient records, difficulty in tracking treatment or procedure orders, difficulty in accessing and formatting patient data for use in medical conferences, lack of advanced searching capability for medical cases, lack of rapid and specific data access for Quality Assurance (QA) and research purposes, lack of an ability to flexibly configure record indices, difficulty in formatting and exporting image files to common file formats for use with common software, higher cost and lack of accessibility in billing procedures, and difficulty in the secure transfer of medical data between medical institutions. Hence, systems and methods that could alleviate these problems may be useful to medical personnel and helpful to patients.

Systems and methods for integrating medical information systems, coding medical data, and exchanging medical data are disclosed.

An integrator may obtain medical data from one or more medical information systems, store the medical data (or link to it) in a database, integrate the medical data, obtain a syntax, obtain rules, obtain (or filter) medical data based on the syntax and/or rules, index the medical data based on the syntax and rules, and output results.

A coder may obtain medical data, analyze the medical data, determine whether the medical data in a case matches a code or mapping, code the case if the medical data matches a code or mapping and generate a bill for the case.

An exchanger may obtain medical data, format the medical data into a byte stream, encrypt the (medical data) byte stream, send the byte stream to a publishing system, obtain group or user rights, associate the group or user rights with the medical data, and send the group or user rights to the publishing system. An exchanger may request medical data from the publishing system, receive medical data from the publishing system, decrypt the medical data, and reconstitute the medical data. A publishing system may receive published medical data, receive group or user rights associated with the medical data, receive a request to download or view the medical data, determine whether the request is authorized (where the request is authorized if the requester is an authorized user or a member of an authorized group), deny access if the request is not authorized or transfer the medical data if the request is authorized.

Various embodiments of the invention are now described with reference to the Figures, where like reference numbers indicate identical or functionally similar elements. The embodiments of the present invention, as generally described and illustrated in the Figures herein, could be arranged and designed in a wide variety of different configurations. Thus, the following more detailed description of several exemplary embodiments of the present invention, as represented in the Figures, is not intended to limit the scope of the invention, as claimed, but is merely representative of the embodiments of the invention.

The word “exemplary” is used exclusively herein to mean “serving as an example, instance, or illustration.” Any embodiment described herein as “exemplary” is not necessarily to be construed as preferred or advantageous over other embodiments.

Many features of the embodiments disclosed herein may be implemented as computer software, electronic hardware, or combinations of both. To clearly illustrate this interchangeability of hardware and software, various components will be described generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present invention.

Where the described functionality is implemented as computer software, such software may include any type of computer instruction or computer executable code located within a memory device and/or transmitted as electronic signals over a system bus or network. Software that implements the functionality associated with components described herein may comprise a single instruction, or many instructions, and may be distributed over several different code segments, among different programs, and across several memory devices.

As used herein, the terms “an embodiment”, “embodiment”, “embodiments”, “the embodiment”, “the embodiments”, “one or more embodiments”, “some embodiments”, “certain embodiments”, “one embodiment”, “another embodiment” and the like mean “one or more (but not necessarily all) embodiments of the disclosed invention(s)”, unless expressly specified otherwise.

The term “determining” (and grammatical variants thereof) is used in an extremely broad sense. The term “determining” encompasses a wide variety of actions and therefore “determining” can include calculating, computing, processing, deriving, investigating, looking up (e.g., looking up in a table, a database or another data structure), ascertaining and the like. Also, “determining” can include receiving (e.g., receiving information), accessing (e.g., accessing data in a memory) and the like. Also, “determining” can include resolving, selecting, choosing, establishing and the like.

The phrase “based on” does not mean “based only on,” unless expressly specified otherwise. In other words, the phrase “based on” describes both “based only on” and “based at least on.”

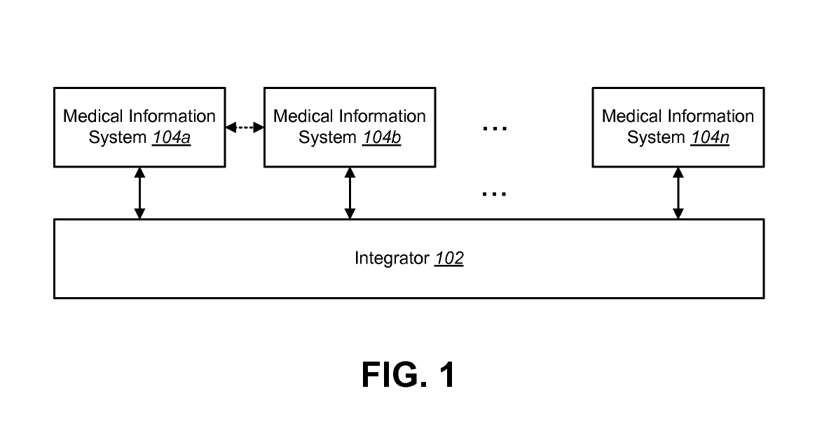

FIG. 1 is a block diagram illustrating one configuration of an integrator. An integrator 102 may be connected to medical information system(s) 104a-n. Medical information system(s) 104a-n may store medical information. For example, medical information system(s) 104a-n may store patient demographic information, medical reports, orders for medical procedures, accession numbers, lab test results, medical history, medical images, etc. Patient demographic information may include, for example: patient name, patient ID number, address, telephone number, email address, age, sex, weight, allergies, social security number, insurance information, etc. Medical reports may include, for example, a text report describing a patient's condition and/or treatment, the treating physician, and a treatment date. A medical history may include, for example, previous treatments, current or prior medication prescriptions, earlier medical reports, etc. Some examples of medical information systems may include Picture Archiving and Communication Systems (PACS), Hospital Information Systems (HIS), Radiology Information Systems (RIS), Clinical Information Systems (CIS), Cardiology Information Systems, Enterprise Data Warehouses (EDW), Laboratory Information Systems (LIS), Voice Recognition Systems, etc. Separate medical information systems 104a-n may include different data. For example, a medical information system 104a may store images, while another medical information system 104b may store medical reports.

An integrator 102 may access, combine, download, store, modify, display, generate new data based on, generate new data collection based on, index, format, link to, and/or otherwise process data from the medical information system(s) 104a-n. The integrator 102 may be connected to the medical information system(s) 104a-n locally and/or via a network such as an intranet or the Internet. The integrator 102 may be configured to be compatible with and operate with a Lightweight Directory Access Protocol (LDAP). The integrator 102 may utilize the security and password features of an LDAP.

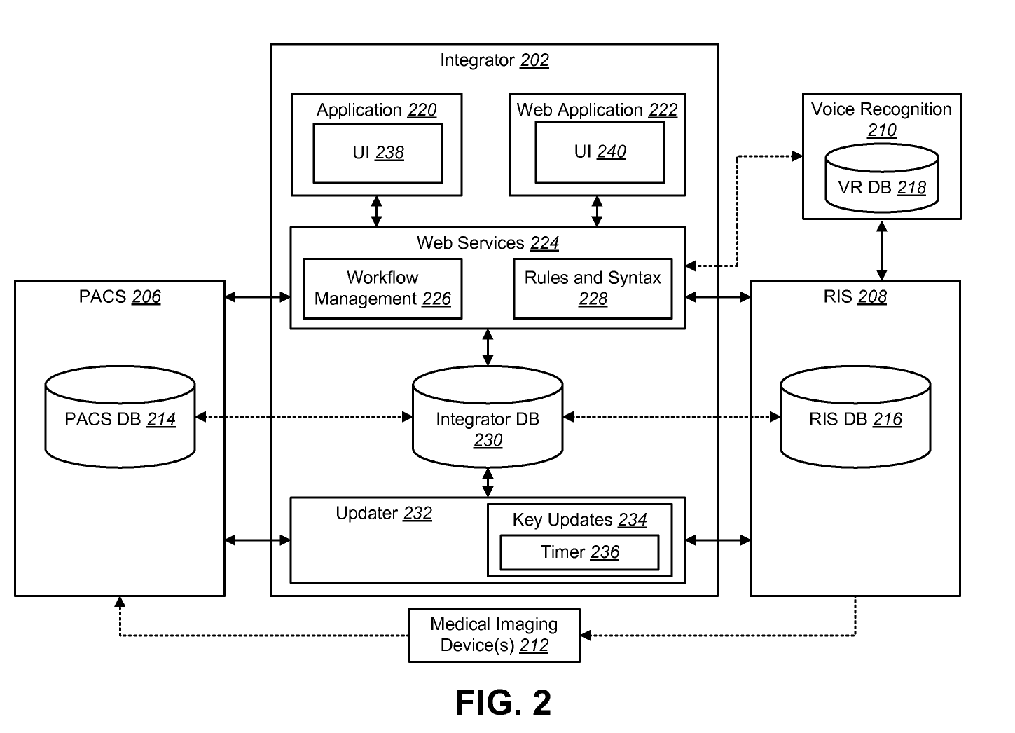

FIG. 2 is a block diagram illustrating another configuration of an integrator 202. The integrator 202 may be connected to a PACS 206, a RIS 208, and a voice recognition module 210. The RIS 208 may be connected to one or more medical imagining device(s) 212. The medical imaging device(s) 212 may be connected to the PACS 206.

The RIS 208 may be a medical information system that stores and provides access to administrative and other information (e.g. a GE® Centricity® RIS). The RIS 208 may be a subsystem of an HIS. The RIS 208 may include one or more RIS databases (DBs) 216. The RIS 208 may receive, index, and store administrative and other information in the RIS DB 216. For example, the RIS DB 216 may store patient demographic information, orders for medical procedures (e.g. imaging orders), medical reports, accession numbers, patient ID numbers, date(s), medical histories and/or other data. The RIS 208 may send imaging orders to the medical imaging device(s) 212.

The medical imaging device(s) 212 may be one or more devices that capture images for use in the medical field. The medical imaging device(s) 212 may include, for example, a Computed Tomography (CT) scanner, Magnetic Resonance Imaging (MRI) scanner, X-Ray machine, Ultrasound (US) machine, Positron Emission Tomography (PET) scanner, Computed Radiography (CR) scanner, Mammogram (MG) equipment, Digital Radiography (DR) equipment, or any other device used to capture images for use in the medical field. The medical imaging device(s) 212 may receive imaging orders from the RIS 208. The medical imaging device(s) 212 may capture and send images and other information to the PACS 206.

The PACS 206 may be a medical information system that stores and provides access to medical images (e.g. AGFA® PACS). The PACS 206 may include one or more PACS DBs 214. The PACS DB 214 may receive, index, and store image and other data. For example, the PACS DB 214 may store medical images, image index information (e.g. accession numbers), modality information (e.g. imaging device type), image capture date, patient demographic information, dates, orders for medical procedures, medical reports, and/or other data. The PACS 206 may receive image and other data from the medical imaging device(s) 212.

The voice recognition module 210 may be a software and/or hardware module that converts speech into text. The voice recognition module 210 may include a voice recognition DB 218. The voice recognition module 210 may receive speech (audio) information from a microphone and convert the information into text. The voice recognition module 210 may be used to dictate reports or transcripts. The voice recognition module 210 may input the text information into the RIS 208. For example, the RIS 208 may receive and store a medical report that was dictated using the voice recognition module 210.

The integrator 202 may be a software and/or hardware module that integrates medical information systems and provides other functionality. The integrator 202 may include an application 220, a web application 222, a web services module 224, an integrator DB 230, and an updater 232. The updater 232 may include key updates 234. The key updates 234 may occur according to a timer 236. The updater 232 may connect to the PACS 206, the RIS 208, and/or other medical information systems. The updater 232 may periodically access the PACS 206 and the RIS 208. The updater 232 may monitor the PACS 206 and/or RIS 208 for added, modified, and/or deleted information. For example, the updater 232 may access the RIS 208 and/or the PACS 206 to update keys every 10 minutes. The updater 232 may update integrator DB 230 keys and other data from the PACS DB 214 and/or the RIS DB 216. The updater 232 may copy (portions of or all) data from the PACS DB 214 and/or RIS DB 216 to the integrator DB 230. For example, the updater 232 may update integrator DB 230 keys with keys from the RIS DB 216 that are associated with new orders and/or keys from the PACS DB 214 that are associated with new images.

The integrator DB 230 may be a DB that stores and/or links to data from medical information systems. The integrator DB 230 may be configured to store (portions of or all) data stored on the PACS DB 214 and/or the RIS DB 216. The integrator DB 230 may be linked to the PACS DB 206 and/or the RIS DB 216. The integrator DB 230 may facilitate indexing and searching for records, cases, or other data based on date, modality (i.e. medical imaging device 212), exam status, patient name, accession number, utilization code, clinical history, or other configurable index. The integrator DB 230 may also include database tables that contain lists such as user lists, institutions, computer connections, etc. The integrator DB 230 may be a Structured Query Language (SQL) server database.

In one configuration, the updater 232 may be omitted from the integrator 202. In that case, there may be a linked server relationship between the integrator DB 230, the PACS DB 214 and the RIS DB 216. Utilizing a linked server relationship, queries directed to the integrator DB 230 may be redirected, pointed, or linked to the PACS DB 214 and/or RIS DB 216. In this manner, little (if any) redundant data may be stored between the integrator DB 230, the PACS DB 214 and the RIS DB 216. For example, the RIS DB 216 may store raw or unprocessed data while the integrator DB 230 may store processed data such that little (if any) unprocessed data is stored in the integrator DB 230.

The web services 224 may be a software and/or hardware module that provides integrator 202 functionality. The web services 224 may provide an interface between several components. For example, the web service 224 may provide functionality and an interface between the application 220, the web application 222, the integrator DB 230, the PACS 206, the RIS 208, and/or the voice recognition module 210. The web services 224 may provide access to the integrator DB 230. For example, the web services 224 may allow the application 220 or web application 222 to display, modify, add data to, or delete data from the integrator DB 230. The web services 224 may allow the application 220 or web application 222 to access the PACS 206 and/or the RIS 208. For example, the web services 224 may allow the web application 222 to display information stored on the PACS 206 and/or the RIS 208. The web services 224 may also allow a user to enter data into the RIS 208 via the voice recognition module 210. For example, a radiologist may use the application 220 to dictate a medical report via the voice recognition module 210, which may then be stored on the RIS 208. The web services 224 may modify the structure and/or functionality of the integrator DB 230. For example, the web services 224 may create, index and link new tables in the integrator DB 230. The web services 224 may otherwise provide additional server-based processing. In one configuration, the web services 224 may manage all or most of the communications between the integrator 202, the PACS 206, and/or the RIS 208.

The web services 224 may provide data searching, retrieval, storage, import/export, indexing, and collection functions. The web services 224 may provide a text search function. For example, the web services 224 may search for user-specified terms in the text of medical reports and output a list of cases or records that match search criteria. Furthermore, the web services 224 may provide a data field search function. For example, the web services 224 may search the integrator DB 230, PACS DB 214, and/or RIS DB 216 based on date, modality, exam status, patient name, patient ID number, date, accession number, utilization code, clinical history, other data fields in the PACS DB 214, other data fields in RIS DB 208 or other user configurable index, etc.

The web services 224 may retrieve medical data. That is, the web services 224 may retrieve medical data specified by a user. For example, the web services 224 may retrieve images from a PACS DB 214 based on DB index information (e.g. an accession number). Furthermore, the web services 224 may retrieve medical data when a user selects a search result from a list of cases or records. The web services 224 may also support documentation of critical findings.

The web services 224 may provide medical data storage functionality. For example, the web services 224 may provide medical imaging study storage functions. For example, the web services 224 may allow a user to store a medical imaging study on the integrator DB 230, a local hard drive, removable media (e.g. thumb drive, CD, DVD, Blu-Ray®, removable hard drive, etc.) or another database. The web services 224 may divide combined studies and store them on the PACS DB 206 under different accession numbers.

The web services 224 may import and/or export medical data. For example, the web services 224 may import or export one or more images or medical reports. Furthermore, the images and/or reports for import or export may be selected from a list or included in a study. For example, the web services 224 may export selected images, medical reports, a list of images, a list of medical reports, or any combination thereof onto local or removable storage media. The web services 224 may automatically assign unique identifiers (e.g. accession numbers) to medical data being imported or exported. The web services 224 may allow a user to manually assign unique identifiers (e.g., accession numbers) to medical data being imported or exported.

When importing or exporting medical data, the web services 224 may convert data formats. That is, the web services 224 may export or import medical data to or from several file formats. For example, the web services 224 may export or import case/record lists or images to or from other image formats or applications. That is, the web services 224 may export and/or convert file formats to or from jpg, png, gif, tiff, bmp, doc or docx (i.e. Microsoft® Word), ppt or pptx (e.g. Microsoft® PowerPoint®), Dicom^{SM}, etc. The web services 224 may also export case lists into Microsoft® Excel® format (i.e. xls or xlsx). When exporting medical data into files or applications, the web services 224 may allow a user (e.g. via the application 220 or web application 222) to export the data to a designated target file. The web services 224 may also support exporting or importing images to or from email attachments.

When exporting or importing medical data to or from files or applications, the web services 224 may automatically map, convert and/or insert header information to accompany the data. When exporting or importing medical data to or from files or applications, the web services 224 may allow manual entry of header information to accompany the data via the application 220 or web application 222. For example, when importing or exporting a Dicom^{SM} file, the web services 224 may add data to or remove data from the header. Such header information may include patient demographics and other information. The web services 224 may provide exportation or importation of medical data to or from a CD, DVD, Blu-Ray™, hard drive, flash drive, network drive, or other media. The web services 224 may convert or map Dicom^{SM} header information in order to export or import Dicom^{SM} files. This conversion or mapping may be used to transfer medical data to or from an institutional PACS 206. The web services 224 may support Dicom^{SM} send functionality.

The web services 224 may provide medical data indexing functionality. For example, the web services 224 may index cases or records based on date, modality, exam status, patient name, accession number, utilization code, clinical history, or other user configurable (e.g. teaching file) index. The web services may thus index medical data stored on the integrator DB 230 according to an existing data field (e.g. accession number, patient name), or the web services may create new keys (e.g. accession numbers) and/or indexes not already existing on the integrator DB 230. For example, the web services 224 may search medical data on the integrator DB 230 according to a user-defined rules and/or syntax. The web services 224 may create a new index based on the rules and/or syntax and index the matching medical data. For example, the web services 224 may produce teaching file indexes. This feature may be user configurable and new or additional case indexes defined by report syntax may be created.

The web services 224 may provide data collection functionality. The web services 224 may dynamically create data collection fields and/or tables based on user-specified rules. The web services 224 may associate a list of cases with the data collection fields or tables. This functionality may allow a user to create or designate data collection fields for research, peer review, Quality Assurance (QA) or other projects. This functionality may also facilitate utilization management functions. The web services 224 may thus facilitate data collection that may be created and tailored by a user. For example, a user may wish to conduct a research study on the psychological effects of an MRI on teenage male patients. Such data may not generally be captured or recorded in the PACS 206 or RIS 208. However, a user may specify the desired research field (e.g. psychological effects of an MRI) for teenage male MRI patients via the application 220 or web application 222. The web services 224 may query one or more DBs (i.e. PACS DB 214, RIS DB 216, integrator DB 230) and obtain a list of cases that includes all cases of teenage male MRI patients. The web services 224 may create data collection fields in the integrator DB 230 for the list of cases and associate those fields with the list. The web services 224 may output the list as a research work list for further data collection. This functionality may also be applied to perform or facilitate the performance of QA functions, peer review functions, research functions, or other projects. For example, the web services 224 may generate work lists for peer review. The web services 224 may also provide random or blind assignment of cases for peer review, QA, research, or other functions. The web services 224 may also provide a framework for utilization management by processing reports and indexing utilization codes as reported by medical personnel (e.g. radiologists).

The web services 224 may include a workflow management module 226. The web services 224 may also include a rules and syntax module 228. The workflow management module 226 may allow a user to use the PACS 206, the RIS 208 or a combination of the two as a workflow manager. For example, a user may use the workflow management module 226 to query the PACS 206 for any CT exams that need to be completed. Also, a user may use the workflow management module 226 to query the RIS 208 for any x-rays that have not been completed. Furthermore, a user may use the workflow management module 226 to obtain and display any undictated studies (e.g. orders that have an image associated with them but do not have a report associated with them).

The web services 224 may include a rules and syntax module 228. The rules and syntax module 228 may process the data in the integrator DB 230 according to user-specified rules and/or syntax. The rules and syntax module 228 may retrieve and/or structure data according to the rules and/or syntax. For example, the rules and syntax module 228 may retrieve records from the DB 230 that have a certain syntax written in a medical report and create a new DB table that is indexed according to that syntax. For example, a user may enter the syntax: “teaching files: bone tumor.” The rules and syntax module may then retrieve all of the records with medical reports that include “teaching files: bone tumor” in the text of the report. The rules and syntax module may then create a new table that has a “bone tumor” index. The new table may still retain certain keys (e.g. accession numbers) and may be linked to other tables. Additionally, a user may specify rules for the rules and syntax module 228. For example, a user may specify that additional data is desired for records that include particular data. The rules and syntax module 228 may retrieve records with the specified data and create a new table that includes fields for the additional data. For example, a radiologist may specify that he wants to obtain professional opinions on cases with a particular amount of radiation exposure for all pelvic CT scans on females. The rules and syntax module 228 may retrieve the records matching the specified criteria (i.e. female pelvic CTs with radiation X). The rules and syntax module 228 may build the records into a new table and append fields for professional opinions. The new table may be expressed as a work list for data collection. That is, radiologists may be tasked with filling the fields for professional opinions. The new table may retain certain keys (e.g. accession numbers) and be linked to other tables.

The application 220 and/or web application 222 may provide access to integrator 202 functionality. The application 220 may be installed and run on a computing device or workstation (e.g. server, desktop computer, laptop computer, etc.). The web application 222 may function on a computing device (e.g. a desktop computer, laptop computer, mobile computing device, etc.) that may connect to the web services 224 over a network (e.g. intranet, the Internet). The application 220 and web application 222 may provide similar or equivalent functionality. The application 220 may include an application user interface (UI) 238. The web application 222 may similarly include a web application UI 240. The application 220 and/or web application 222 may provide a user with access to and display of information stored on the integrator DB 230, the PACS 206 and/or the RIS 208. For example, the application 220 and/or web application 222 may list and display images, medical reports or medical history (e.g. historical exams) for a selected patient. The web application 222 may also allow a user to easily access and modify integrator DB 230 tables that may contain lists such as user lists, institutions, computer connections, etc. The application 220 and/or web application 222 may also display a medical report (e.g. radiology report) for a selected study. The application 220 and/or web application 222 may provide a user with access to retrieval, storage, and display of medical imaging studies. The application 220 and/or web application 222 may remove or otherwise conceal identifiable patient information (e.g. when displaying or storing images or reports). The application 220 and/or web application 222 may support conferencing functionality by allowing users to add studies to a conference list and retrieve and view images or medical reports from the conference list (via the web services 224).

The application 220 and/or web application 222 may display medical data. The application 220 and/or web application 222 may display one or more medical images, medical reports, or other medical data. The application 220 and/or web application 222 may display the current status of an order (e.g. radiology order). The application 220 and/or web application 222 may also provide medical data processing functionality. For example, the application 220 may provide image window/level adjustment, flip, rotation, zoom, selection, scroll, cine, and length/angle measurement, etc. The application 220 and/or web application 222 may provide other image enhancement, adjustment, or processing techniques. For example, the application 220 and/or web application 222 may provide image contrast adjustment, cropping, coloration, text labeling, etc. While the application 220 and/or web application 222 may provide a viewer, the application 220 and/or web application may also interface directly with a PACS (e.g. an AGFA® PACS system).

The application 220 and/or web application 222 may provide medical data selection functionality. That is, the application 220 and/or web application 222 may allow a user to select one or more pieces of medical data in order to perform a particular operation on the data. For example, the application 220 and/or web application 222 may allow a user to select one or more images, medical reports, patients, studies, etc. The integrator 202 may then perform a particular operation on the data. For example, a user may select several medical images, medical reports, and/or other medical data for import or export. A user may also select several medical images, medical reports, and/or other medical data for download or storage on local or removable storage media.

The application 220 and/or web application 222 may include a data collection form. The data collection form may be used to specify data to be collected and data entered through the collection form may be used to trigger generation of additional work list items. For example, the data collection form may be used to generate work lists for peer review, QA, research, or other projects. The application 220 and/or web application 222 may provide an import/export wizard. The import/export wizard may allow a user to input format, location, and other information necessary or desirable during the import/export process. The web services 224 may store such import/export information. The web services 224 may allow a user to repeat an import/export process without repeating all or part of the input necessary or desirable during an import/export process. The web services 224 may automatically display files via the application 220 or web application 222 that may be imported when removable media is inserted into a computing device on which the application 220 and/or web application 222 is running. The web services 224 may automatically begin or run the importation process when removable media is inserted into the computing device. The application and/or web application 222 may filter files stored on media in order to display only files that may be imported.

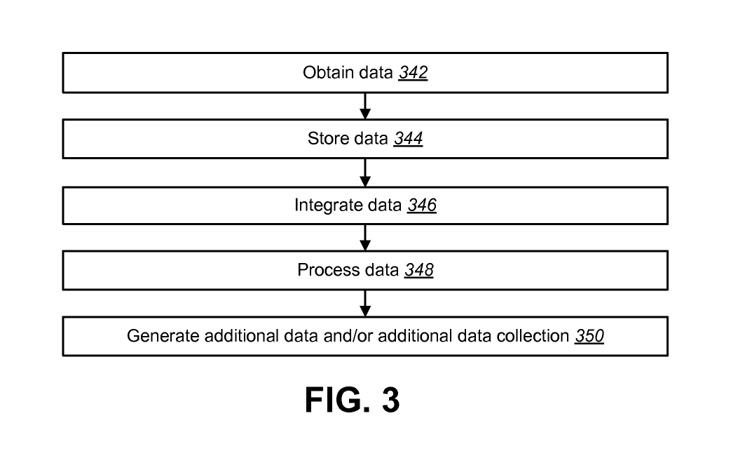

FIG. 3 is a flow diagram illustrating a method for integrating medical information systems. An integrator 202 may obtain 342 data from one or more medical information systems 104a-n. That is, the integrator 202 may obtain data from a RIS 208 and a PACS 206. In particular, the integrator 202 may copy keys from the RIS DB 216 and the PACS DB 214. The integrator 202 may also obtain other data from the PACS 206 and the RIS 208. For example, the integrator 202 may download images from the PACS DB 214; other data from the voice recognition DB 218; and patient demographic data, medical reports, orders, and other medical data from the RIS DB 216. The integrator 202 may alternatively obtain 342 linking data such that the medical data on the RIS 208 and PACS 206 is not downloaded.

The integrator 202 may store 344 data on the integrator DB 230. The data may be in Dicom^{SM} format. The integrator 202 may store 344 data on the integrator DB 230 based on keys contained in the PACS DB 214, the RIS DB 216. For example, the data stored on the integrator DB 230 may be organized according to accession or order numbers (i.e. keys) that are contained in the PACS DB 214 and the RIS DB 216. The integrator 202 may integrate 346 the data obtained from the PACS 206, RIS 208, and the voice recognition module 210. For example, the integrator 202 may combine image data from the PACS 206 and patient demographic data and medical report data from the RIS 208. The data may be integrated such that the data that is available separately on the PACS 206 and the RIS 208 is available on one computing device or workstation via the application 220 or the web application 222.

The integrator 202 may process 348 the data on the integrator DB 230. That is, the integrator 202 may provide certain data processing functionality. The integrator 202 may display and manipulate data via the application 220 or web application 222. For example, the integrator 202 may process image data by flipping, rotating, cropping, selecting, copying, printing, scaling, zooming, adjusting contrast, coloring, text labeling, measuring length or angles in, scrolling, selecting, adjusting a window or level of, or providing cine functionality for an image. The integrator 202 may convert image formats. For example, the integrator 202 may convert a Dicom^{SM} image to a jpg, png, gif, tiff, xls or xlsx, doc or docx, ppt or pptx, or bmp format. The integrator 202 may also convert other file formats to Dicom^{SM} format. The integrator 202 may also format data for import or export. For example, the integrator may remove sensitive patient demographic information from a Dicom^{SM} file, such that the image may be presented in a conference, exported or published without compromising patient demographic information. The integrator 202 may store data contained in the integrator DB 230, PACS DB 214 and/or the RIS DB 216 on local or removable media. For example, the integrator 202 may store a medical report from the RIS 208 and a corresponding Dicom^{SM} image from the PACS 206 on a thumb drive. The integrator 202 may also retrieve data based on search terms entered by a user via the application 220 or the web application 222. That is, the integrator 202 may search user-designated fields in the integrator DB 230, the PACS DB 214 and/or the RIS DB 216 for information matching or related to a user-designated search term. For example, a user may specify (via the application 220 or web application 222) a search for chest x-rays of males where congestion was dictated in the medical report. The integrator 202 may search the integrator DB 230 for males in a patient demographic information field, chest x-rays in an order information field, and the term congestion (or related terms) in the text of medical reports. The integrator 202 may then display the search results to a user via the application 220 or web application 222.

The integrator 202 may also generate 350 additional data and/or data collection. The integrator 202 may generate data based on the data on the PACS 206 and/or the RIS. For example, the integrator 202 may track medical orders based on data stored on the PACS 206 and/or RIS 208. More specifically, the integrator 202 may determine whether an ordered imaging procedure has been completed and/or dictated. That is, the integrator 202 may determine whether order data on the RIS 208 has image data associated with it on the PACS 206. Furthermore, the integrator 202 may determine whether the order and/or image data has a dictated report associated with it on the RIS. Based on this information, the integrator 202 may generate, determine, and fill a “status” data field on the integrator DB 230 that is associated with the image and/or order data.

The integrator 202 may generate 350 additional data collection. More specifically, the integrator 202 may dynamically create associated data structures, data collection forms, work lists and/or assignments. The integrator 202 may search for particular cases on the integrator DB 230 that meet user-specified criteria. The integrator 202 may create and index a new data structure (e.g. a field or table) in the integrator DB 230. The new data structure may include additional fields for data collection. The integrator 202 may create a work list based on the data to be collected. The integrator 202 may also assign work list items to particular users. This functionality may be useful in many applications, including QA, peer review, utilization management and research. For example, a user may want to research whether a particular amount of radiation is necessary for pelvic CTs on females. The integrator 202 may search the integrator DB 230, the PACS DB 214, and/or the RIS DB 216 and retrieve all of the cases including pelvic CT scans on females using a certain amount of radiation. The integrator 202 may create a new data table in the integrator DB 230 that is associated with those cases. The integrator 202 may create a text field in the new data table for radiologists to dictate whether the particular amount of radiation was necessary for those cases. The cases and the associated data collection may be designated as a research study. The integrator 202 may create a work list for data collection. The integrator 202 may assign work list items to radiologists for completion. A radiologist may view the study and work list via the application 220 or web application 222. The integrator 202 may dynamically generate and display a data collection form via the application 220 or web application that includes a text box where the radiologist may dictate whether the particular amount of radiation was necessary for the particular case at hand. The radiologist may fill the text box via the voice recognition module 210 or by typing a response.

Additionally, the integrator 202 may provide a syntax-driven indexing function. The integrator 202 may search a specified field in the integrator DB 230, the PACS DB 214, and/or the RIS DB 216 for a specified term. The integrator 202 may dynamically create a new data structure (e.g. field or table) in the integrator DB 230 that is indexed according to the term. For example, text fields in medical reports on the RIS 208 DB 216 may include a specific syntax. For instance, the some medical reports may include the syntax “teaching files: bone tumor” while other reports may include the syntax “teaching files: radiation.” The integrator 202 may search for medical reports that contain the category “teaching files.” More specifically, the integrator 202 may search for medical reports that contain “teaching files” and the colon “:” delimiter. The integrator 202 may dynamically create a new table in the integrator DB 230 with a category (e.g. a column) designated “teaching files.” The table may index medical data associated with the cases that included the “teaching files: x” syntax. More specifically, the table may include “teaching file” cases, where some include a “bone tumor” index key and some include a “radiation” index key. The integrator may further create new data collection fields (e.g. text, Boolean, character, number, images, etc.), work lists, assignments, and/or data collection forms associated with the new data structure with a syntax-driven index.

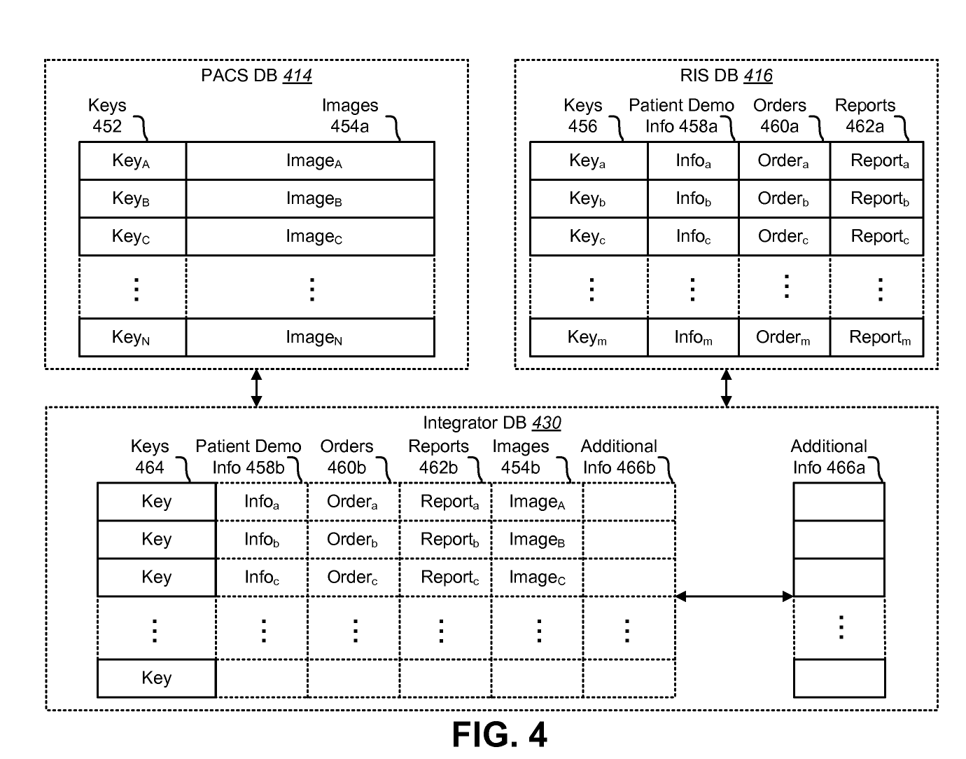

FIG. 4 is a block diagram illustrating medical information system integration. A PACS DB 414 may include a data table. The PACS DB 414 data table may include keys 452 and images 454a. The PACS DB 414 data table may include other information. For example, the PACS DB 414 data table may include order information, patient demographic information, image date and time, modality, etc. The keys 452 may be codes or data that uniquely identify the images 454a. The keys 452 may be accession numbers, for example. The PACS 406 may use the keys 452 to index the images 454a in the PACS DB 414 data table.

A RIS DB 416 may also include a data table. The RIS DB 416 data table may include keys 456, patent demographic information 458a, orders 460a, and reports 462a. The RIS DB 416 data table may include other information. For example, the RIS DB 416 data table may include order numbers, patient index numbers, etc.

The integrator DB 430 may also include a data table. The integrator DB 430 data table may include keys 464 and other information. For example, the integrator 430 data table may include patient demographic information 458b, order information 460b, report information 462b, image data 454b, and additional information 466b, etc. The integrator DB 430 keys 464 may be the same as PACS DB 414 keys 452 and/or RIS DB 416 keys 456. The integrator DB 430 keys 464 may be some other keys used for indexing. Alternatively, the integrator DB 430 data table may only store key information from the PACS DB 414 data table and the RIS DB 416 data table. In this case, the integrator DB 430 data table may link to the data fields on the PACS DB 414 and the RIS DB 416. For example, the integrator DB 430 data table may link the patient demographic information 458b to the patient demographic information 458a, the orders 460b to the orders 460a, the reports 462b to the reports 462a, and the images 454b to the images 454a. Similarly, the integrator DB 430 may create and link to a table containing additional information 466a not found on the PACS DB 414 or RIS DB 416. More specifically, the integrator DB 430 may link additional information 466b to additional information 466a. For example, the integrator 202 may create and link a table that includes status information 466a for each of the orders 460b. The integrator 202 may determine and fill the status information 466a for each of the orders 460b based on data obtained from the PACS DB 414 and the RIS DB 416. For example, the integrator 202 may determine an order status based on whether an Image_{A} 454b and a Reportₐ 462b are associated with an Orderₐ 460b.

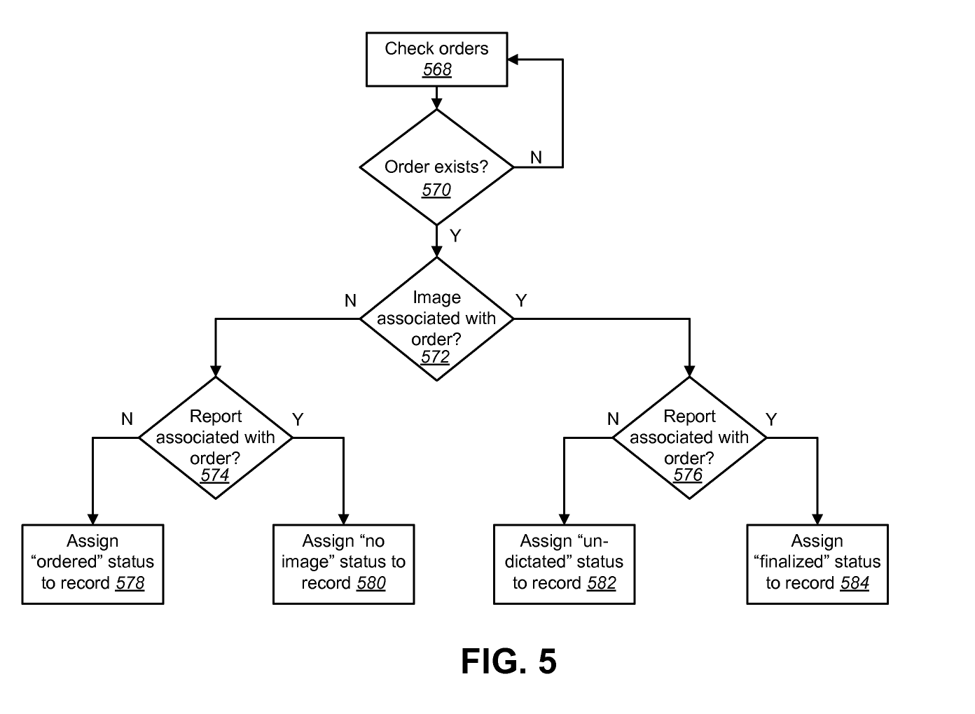

FIG. 5 is a flow diagram illustrating a method for determining an order status. This method may be used to track the status of an order. An integrator 202 may check 568 order information (e.g. on the integrator DB 430 or the RIS DB 416). The integrator 202 may determine 570 whether a non-finalized or new order exists. If an order does not exist, the integrator 202 may return to check 568 for orders (e.g. at a scheduled interval or otherwise). If an order exists, the integrator 202 may determine 572 whether an image is associated with the order (i.e. on the integrator DB 430 or the PACS DB 414). If an image is not associated with the order, then the integrator 202 may determine 574 whether a report is associated with the order (i.e. on the integrator DB 430 or the RIS DB 416). If a report is not associated with the order, the integrator 202 may assign 578 an “ordered” status 466b to the order record on an integrator DB 430 data table. If a report is associated with the order, the integrator 202 may assign 580 a “no image” status 466b to the order record on an integrator DB 430 data table. If an image is associated with the order, the integrator 202 may determine 576 whether a report is associated with the order. If no report is associated with the order, the integrator may assign 582 an “undictated” status 466b to the order record on an integrator DB 430 data table. If a report is associated with the order, the integrator 202 may assign 584 a “finalized” status 466b to the order record on an integrator DB 430 data table.

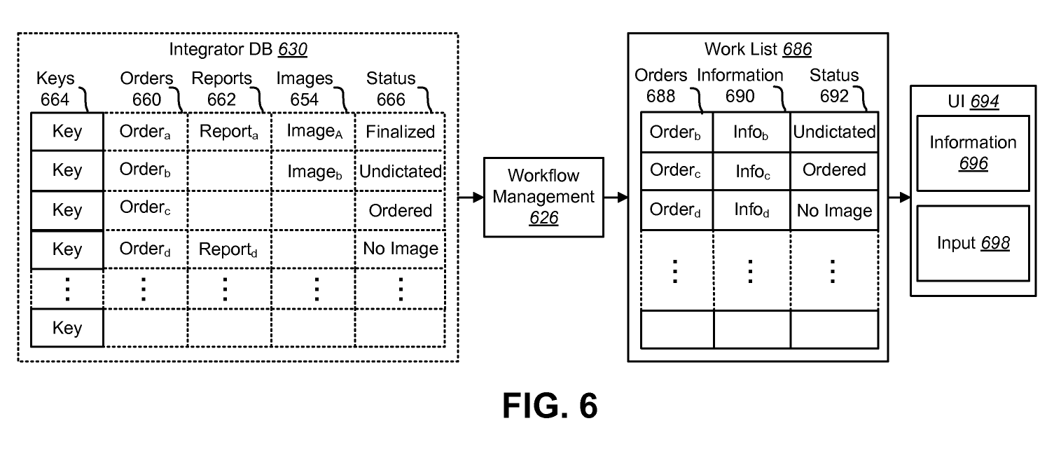

FIG. 6 is a flow diagram illustrating a method for workflow management. An integrator DB 630 may include keys 664, orders 660, reports 662, images 654, and status information 666. A workflow management module 626 may check the integrator DB 630 to determine order status. For example, the workflow management module 626 may determine that an Orderₐ has a “Finalized” status because the Orderₐ has both an Imageₐ and a Reportₐ associated with it. However, the workflow management module 626 may determine that Order_{b} has an “Undictated” status because Order_{b} has an Image_{b}, but no associated dictated report. Furthermore, the workflow management module 626 may determine that Orderₛ has an “Ordered” status because Orderₛ has neither an associated image, nor a report. Furthermore, the workflow management module 626 may determine that Order_{d} has a “No Image” status because Order_{d} has a Report_{d} associated with it, but no image. The statuses 666 are indicated before the workflow management module 626 for convenience, though they may not be determined until after the workflow management module 626. The workflow management module 626 may generate a work list 686 based on the integrator DB 630 data. For example, the workflow management module may generate a work list 686 containing orders 688, information 690 (e.g. order information, patient demographic information, modality, image(s), etc.), and status information 692. The work list 686 may also contain other information, such as patient name, accession number, etc. The work list 686 may display all of the orders without a “Finalized” status. For example, the work list 686 may display an “Undictated” Order_{b} and information 690 associated with the Order_{b}. Furthermore, the work list 686 may display an “Ordered” Orderₛ and information 690 associated with the Orderₛ. Furthermore, the work list 686 may display a “No Image” Order_{d} and information 690 associated with the Order_{d}. When a user accesses the work list 686 (e.g. via an application 220 UI 238 or a web application 222 UI 240), the integrator 202 may dynamically generate a data collection UI 694. The UI 694 may display information 696 and an input field 698 (e.g. textbox, check box, radio button(s), etc.). For example, if a user selects a work list 686 item Order_{b}, the integrator 202 may display the Images associated with Order_{b} in the information display 696. The integrator 202 may also provide a text box input 698 for a user to dictate a medical report for Order_{b}. In this manner, the workflow management module 626 may track and manage orders that need to be completed.

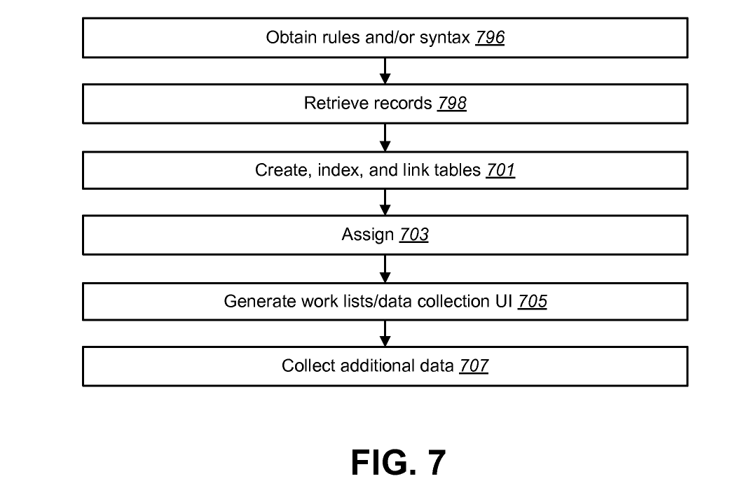

FIG. 7 is a flow diagram illustrating one configuration of a method for dynamic data structure creation and data collection in a medical services environment. An integrator 202 may obtain 796 rules and/or a syntax from a user (e.g. via an application 220 UI 238 or a web application 222 UI 240). A rule may be user-specified criteria. For example, a rule may be an instruction to collect a certain type of data for particular cases in the integrator DB 230 that meet specified criteria. Or, a rule may be an instruction to automatically generate data based on existing data. Or, a rule may be simply be an instruction to return all cases where male patients aged 50+ underwent an x-ray for a broken femur. A syntax may be data that specifies an index and keys. For example, a syntax may be strings of characters including a delimiter for a particular data field. For example, one syntax may be “conference: chest x-rays” in medical reports. For example, as a radiologist takes chest x-rays, he may desire to retrieve the results at a later time for a medical conference. As he dictates medical reports with chest x-rays, he may insert the syntax “conference: x-rays”. However, he may also want to retrieve data for head CTs for a medical conference. Thus, the radiologist may insert the syntax “conference: head CTs” in the text of dictated medical reports. In the example, the index may be a “conference” index, and “x-rays” and “head CTs” may be keys or entries in that index. The integrator 202 may retrieve 798 records. More specifically, the integrator 202 may search for and/or retrieve records in the integrator DB 230 that match the rules and/or syntax.

The integrator 202 may create, index, and/or link 701 data structures. Based on the user-specified rules and/or syntax and the retrieved records, the integrator may create 701 tables in the integrator DB 430, index 701 them according to the syntax (if specified) and link 701 the tables or their records to the integrator DB 430 data table. For example, if additional data 466a is to be generated and/or collected according to the user-specified rules and/or syntax, the integrator 202 may dynamically create a new data table. The new data table may include data fields that may be filled with integrator 202 generated data (according to the user-specified rules) or filled by a user. The integrator 202 may index 701 the table according to the user-specified syntax. For example, the data table index may be a “conference” index, with “x-rays” and “head CTs” as index keys or entries. The integrator 202 may also link the new data table with the integrator DB 430 data table. For example, the integrator 202 may copy keys from the integrator DB 430 table such that corresponding records in the integrator 202 DB may be associated with or linked to the records in the new data table.

The integrator 202 may assign 703 records for data collection. This functionality may be used for workflow management, utilization management, research, peer review and/or QA, etc. For example, the integrator 202 may generate a table of records that match certain criteria and append a data field for peer review. The integrator 202 may then assign 703 records to one or more medical personnel for peer review. The record assignment may be random and/or blinded. The integrator 202 may generate 705 work lists and/or data collection UIs. For example, the integrator 202 may generate 705 and display a work list of assigned tasks for a radiologist via the application 220 or web application 222. When the radiologist selects one of the tasks, the integrator 202 may generate 705 a data collection UI. For example, the integrator 202 may display a UI that includes a text box for peer review comments from the radiologist. That is, the integrator 202 may generate 705 a data collection UI based on the data collection fields in the integrator DB 430 data table. For example, if a data collection field is a text field, the integrator 202 may generate 705 a UI text box for data entry. If a data collection field is a Boolean, the integrator 202 may generate 705 a UI check box for data entry. The integrator 202 may generate 705 other UI controls based on the number and data type of the data collection fields (and/or user preference). The integrator 202 may collect 707 additional data. For example, the integrator 202 may store data entered by a user through the data collection UI. If the data to be collected may be generated based on the user-specified rules and the data already available, the integrator 202 may generate and store the additional data.

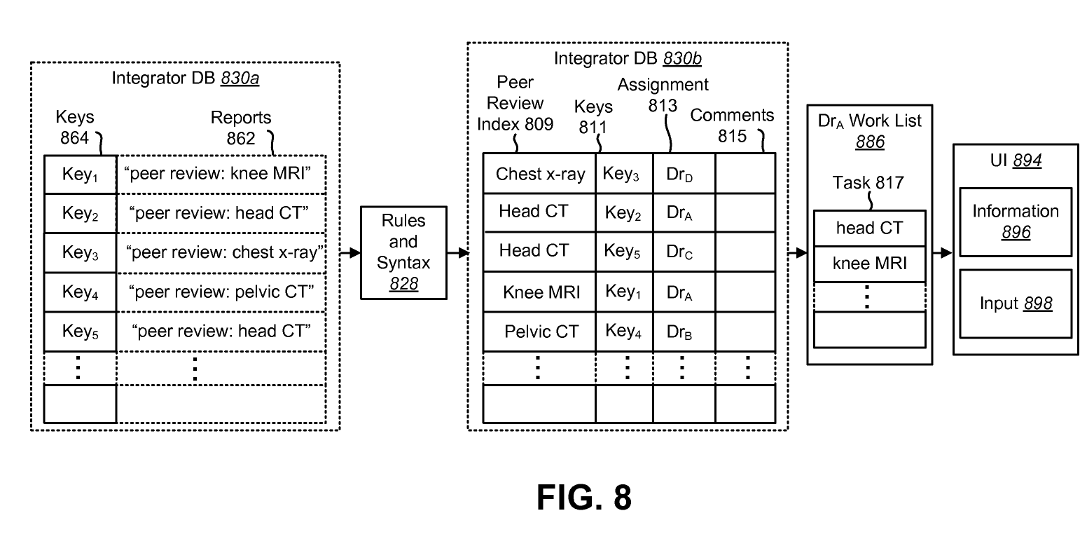

FIG. 8 is a flow diagram illustrating one example of a method for dynamic data structure creation and data collection in a medical services environment. An integrator DB 830a may include a data table which may include keys 864 and medical reports 862. The medical reports may include text with a particular syntax. For example, five particular medical reports may include: “peer review: knee MRI”, “peer review: head CT”, “peer review: chest x-ray”, “peer review: pelvic CT”, and “peer review: head CT”. A rules and syntax module 828 may obtain (e.g. from a user) a rule to obtain comments (e.g. text) from randomly assigned radiologists in records including a “peer review” syntax in the text of medical reports 862. The integrator 202 may retrieve the records including the “peer review” syntax in the medical report text. The integrator 202 may create a new table in the integrator DB 830b. The integrator 202 may index the records according to the “peer review” syntax. For example, the integrator 202 may create a “peer review” index 809, and associate the data entries “chest x-ray”, “head CT”, “head CT”, “knee MRI” and “pelvic CT” with their corresponding records. The integrator 202 may also link the new table in the integrator DB 830b to the original table in the integrator DB 830a using keys 811. The integrator 202 may also create two new data fields: an assignment data field 813 and a comments data field 815. The integrator 202 may then randomly (or otherwise) assign radiologists to the records in the new table included in the integrator DB 830b. The integrator 202 may avoid assigning radiologists to perform peer review that also authored the medical reports 862. For example, the integrator 202 may assign Dr_{D} to the “chest x-ray” record, Dr_{A} to the “head CT” (Key₂) and the “knee MRI” records, Drc to the “head CT” (Key₁) record, and Dr_{B} to the “pelvic CT” record. The integrator 202 may generate a work list 886. For example, the integrator may generate a work list 886 for Dr_{A} including tasks 817 associated with the “head CT” (Key₂) and “knee MRI” records. When Dr_{A} selects a task, the integrator may generate a UI 894. The UI 894 may include information 896 and an input 898 (e.g. text box). For example, the information 896 may display the image corresponding to the “knee MRI” record. Dr_{A} may input his peer review comments in the text box 898. The integrator 202 may store the text data in the comments 815 data field corresponding to the “knee MRI” record.

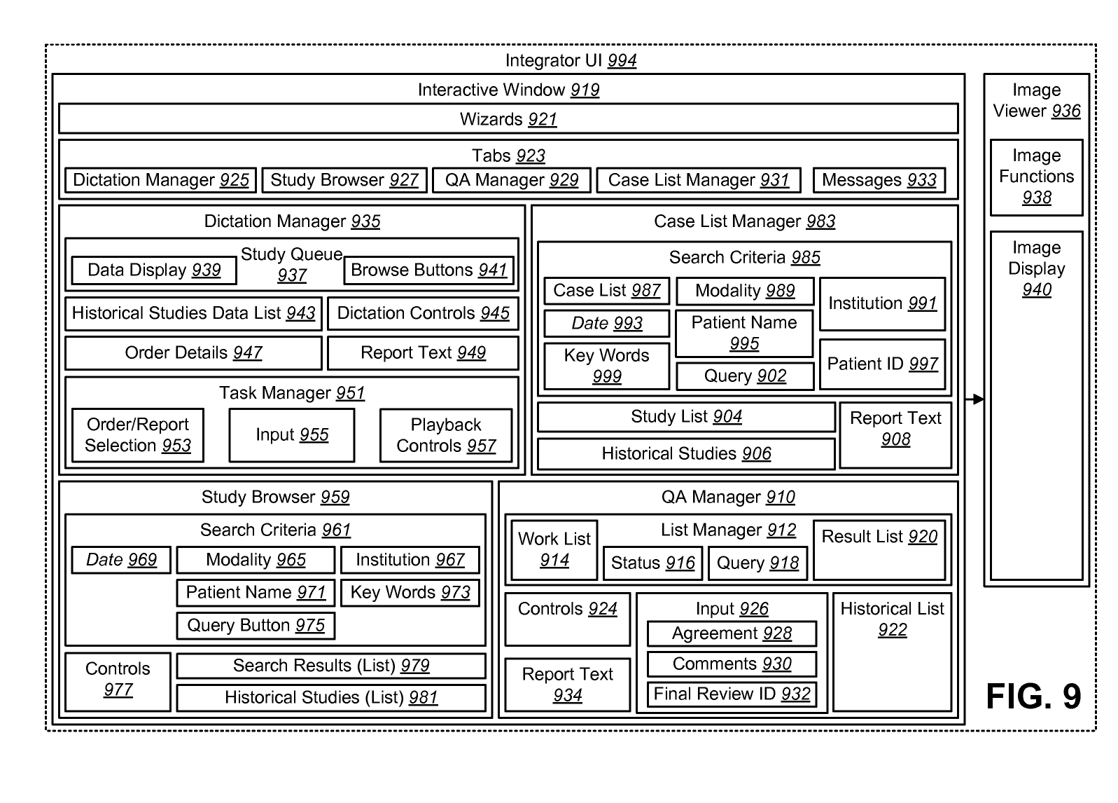

FIG. 9 is a block diagram illustrating one configuration of an integrator UI 994. The integrator UI 994 may include an interactive window 919 and an image viewer 936. The interactive window 919 may include wizards 921, tabs 923, a dictation manager 935, a study browser 959, a case list manager 983, and a QA manager 910. The wizards 921 may include several buttons that a user may click to trigger wizards. The tabs 923 may include several tabs that a user may click to select one of several displays. For example, the interactive window may display the dictation manager 935 if a user clicks the dictation manager tab 925, the study browser 959 if a user clicks the study browser tab 927, the QA manager 910 if a user clicks the QA manager tab 929, the case list manager 983 if a user clicks the case list manager tab 931, or a messages display if a user clicks on the messages tab 933.

The dictation manager 935 may include a study queue 937, historical studies data list 943, dictation controls 945, order details 947, report text 949, and a task manager 951. The study queue 937 may include a study data display 939 and browse buttons 941. The study data display 939 may display data corresponding to a particular study. For example, the study data display may display an accession number, patient name, patient ID number, study description, study date, modality, status, institution ID, age, and location, etc. The browse buttons 941 may include a clear button, a prior button, and a next button. These buttons may be used to clear the current study view, go to a prior study in a list of studies, and go to a next study in a list of studies, respectively. The historical studies data list 943 may display historical studies data of the same patient that is currently displayed in the study data display 939.

The dictation controls 945 may include several buttons used for case dictation. For example, the dictation controls 945 may include a “Dictate Case” button, a “Cancel Dictation” button, a “Sign Case” button, a “Hide Case” button, and a “Save Dictation” button. The “Dictate Case” button may activate a dictation function or application. For example, when a user clicks the “Dictate Case” button, the integrator 202 may allow the user to dictate a case, either through text or voice entry. For example, a user may input text and/or voice as a recording and/or transcription. For example, the integrator may activate the voice recognition module 210 (e.g. PowerScribe) to record and/or transcribe dictation on a particular case. The “Cancel Dictation” button may be used to cancel the dictation on a particular case. The “Sign Case” button may allow a user to sign the case. For example, a radiologist may sign a dictated case. The “Hide Case” button may conceal a particular case from view. The “Save Dictation” button may cause the integrator 202 to save any dictation (e.g. voice or text) and associate it with the current case.

The order details 947 may display order data associated with a selected study. For example, the order details 947 may display data associated with a selected study on the historical studies data list 943. For example, the order details may display a patient name, accession number, exam description, exam date, date of birth (DOB), patient age, patient sex, attending physician, ordering physician, history, diagnosis, etc. The report text 949 may display the text of a medical report (if one exists) that is associated with a selected study on the historical studies data list 943. The task manager 951 may display orders and/or reports to be completed by a user. The order/report selection 953 module may be tabs that may select whether orders or reports are displayed by the task manager 951. The input 955 may be a text box or other control that may allow a user to input data. For example, a radiologist may use the input 955 to type text into a medical report. Furthermore, a user may use the input 955 to dictate a medical report via voice recognition software. The playback controls 957 may allow a user to control the playback of a recorded voice file. For example, when a radiologist is dictating a medical report, he may wish to review or revise his dictation. The playback controls 957 may allow the radiologist to do so. The playback controls may also allow a user to listen to dictation associated with another selected case or medical report.

The study browser 959 may include search criteria module 961, controls 977, a list of search results 979, and a list of historical studies 981. The search criteria 961 may include several input fields. For example, the search criteria module 961 may include modality 965, institution 967, date 969, patient name 971, key words 973, and a query button 975. The modality input 965 may be an input control that may allow a user to specify a modality as a search criterion. For example, the modality input 965 may be a text box, a drop-down list, a series of check boxes, etc. For example, a user may use the modality input 965 to specify (e.g. select) a modality as a search criterion such as an MRI, CT, etc. The institution input 967 may be an input control that may allow a user to specify an institution as a search criterion. For example, a user may use the institution input 967 to specify a particular hospital or medical institution as a search criterion. The date input 969 may be an input control that may allow a user to specify a date or range of dates as a search criterion. For example, a user may use the date input 969 to specify a date range in which the integrator 202 may search for cases (e.g. Jan. 1, 2009 to Feb. 15, 2009). The patient name input 971 may be an input control that may allow a user to specify a patient name as a search criterion. For example, a user may use the patient name input 971 to specify that he wishes to search for cases where John Doe was the patient. The key words 973 input may be one or more input controls that may allow a user to specify a search term or “key word” as a search criterion. For example, a user may use the key words 973 input to specify words and/or phrases that the integrator 202 may use to search the text of a medical report (or other field). The key words 973 input may also allow a user to specify a particular field to search (e.g. medical report, age, gender, patient ID, utilization code, etc.). Furthermore, the key words input 973 may allow a user to apply Boolean logic to the search. For example, a user may use the key words input 973 to obtain only those cases where both “coughing” and “sneezing” was included in the medical report. The query button 975 may be a button that will activate a search for cases when clicked. For example, the integrator 202 may search for cases meeting all or some of the search criteria inputs 965, 967, 969, 971, 973, etc. While only some search criteria inputs are shown in FIG. 9, additional or other search criteria inputs may be used.

The controls 977 may include buttons that may allow certain functionality. For example, the controls 977 may include a “clear all” button that clears the list of search results 979. The controls 977 may also include a “view selected” button that causes one or more images associated with one or more selected cases (e.g. on the search results list 979 and/or the historical studies list 981) to be displayed in the image display 940 when clicked. The list of search results 979 may display a list of cases that match some or all of the search criteria specified in the search criteria module 961. The list of search results 979 may allow a user to select one or more of the search results for other operations. The list of historical studies 981 may include a list of cases that are associated with a selected case on the list of search results 979. For example, when a user selects a case displayed on the list of search results 979, the list of historical studies 981 may display historical studies associated with the patient of the selected case. The list of historical studies 981 may allow for one or more of the studies displayed to be selected for other operations. The list of historical studies 981 may also display case data. For example, it may display accession numbers, dates, modalities, order information, etc.

The QA manger 910 may include a list manager 912, a list of historical studies 922, controls 924, input module 926, and report text 934. The list manager 912 may include a work list input 914, status input 916, and a query button 918. The work list input 914 may be an input control used to select or specify which work list to display. For example, the work list input may be a text box, drop-down list, a series of check boxes, or a series of radio buttons, etc. where a user may designate which work list the result list 920 displays. The status input 916 may be an input control used to specify the status of cases to be displayed. For example, the status input may be a text-box, drop-down list, a series of check boxes, or a series of radio buttons, etc. where a user may designate the status of cases to be displayed on the result list 920. For example, the status input 916 may filter cases such that only the “undictated” or “ordered” cases are displayed in the result list 920. The query button 918 may be a control input that initiates a search and/or retrieval of cases to be displayed in the result list 920. The result list 920 may be a list of cases that match the work list input 914 and status input 916 criteria. The result list 920 may display case data. For example, the result list may display one or more accession numbers, patient ID numbers, patient names, and data statuses associated with the cases in the result list 920.

The list of historical studies 922 may include a list of cases that are associated with a selected case on the result list 920. For example, when a user selects a case displayed on the list of results 920, the list of historical studies 922 may display historical studies associated with the patient of the selected case. The list of historical studies 922 may allow for one or more of the studies displayed to be selected for other operations. The controls 924 may include input buttons used to browse studies in the result list 920. For example, the controls 924 may include a “Prior” button and a “Next” button used to browse the studies in the result list 920. The input module 926 may include an agreement input 928, a comments input 930, and a final reviewer ID input 932. The agreement input 928 may be an input control used to specify whether a reviewer agrees with the contents of the case that is being reviewed (e.g. medical report, diagnosis, etc.). For example, the agreement input 928 may be a text box, drop-down list, one or more check boxes, and/or one or more radio buttons. The agreement input 928 may specify whether a review agrees or disagrees with the contents of the case being reviewed. The agreement input 928 may also include other options (e.g. no basis to review, etc.). The comments input 930 may be an input control used to input comments. For example, a radiologist may use the comments input 930 to input his comments concerning the case being reviewed. The final reviewer ID input 932 may be an input control used to input the identification of the final reviewer. For example, the final reviewer ID input may be a text box, a drop-down list, one or more checkboxes, or one or more radio buttons that a reviewer may use to enter his identification (e.g. name). The report text display 934 may display the text of a medical report that is associated with the case being reviewed.

The case list manager 983 may include a search criteria module 985, a list of studies 904, a list of historical studies 906 and a report text display 908. The search criteria 985 may include several input fields. The input fields may each be a text box, a drop-down list, one or more check boxes, and/or one or more radio buttons, etc. For example, the search criteria module 985 may include a case list input 987, modality input 989, institution input 991, date input 993, patient name input 995, patient ID input 997, key words input 999, and a query button 902. The case list input 987 may be an input control that may allow a user to specify a case list as a search criterion. The modality input 989 may be an input control that may allow a user to specify a modality as a search criterion. For example, a user may use the modality input 989 to specify (e.g. select) a modality as a search criterion such as an MRI, CT, etc. The institution input 991 may be an input control that may allow a user to specify an institution as a search criterion. For example, a user may use the institution input 991 to specify a particular hospital or medical institution as a search criterion. The date input 993 may be an input control that may allow a user to specify a date or range of dates as a search criterion. For example, a user may use the date input 993 to specify a date range in which the integrator 202 may search for and/or retrieve cases (e.g. Jan. 1, 2009 to Feb. 15, 2009). The patient name input 995 may be an input control that may allow a user to specify a patient name as a search criterion. For example, a user may use the patient name input 995 to specify that he wishes to search for cases where John Doe was the patient. The key words input 999 may be an input control that may allow a user to specify a search term or “key word” as a search criterion. For example, a user may use the key words 999 input to specify words and/or phrases that the integrator 202 may use to search the text of a medical report (or other field). Furthermore, the key words input 999 may allow a user to apply Boolean logic to the search. For example, a user may use the key words input 999 to obtain only those cases where both “coughing” and “sneezing” was included in the medical report. The query button 902 may be a button that may activate a search for cases when clicked. For example, the integrator 202 may search for cases meeting all or some of the search criteria inputs 987, 989, 991, 993, 995, 997, 999, etc. While only some search criteria inputs are shown in FIG. 9, additional or other search criteria inputs may be used.

The image viewer 936 may be an interactive window that displays and manipulates images. The image viewer 936 may include image functions 938 and one or more image displays 940. The image display 940 may display one or more images (if available) based on which case, study, record, or result is selected in the interactive window 919. The image functions 938 may include several input controls that may be used to manipulate the image being displayed or its appearance. For example, the image functions may include functions for flipping, rotating, cropping, scaling, zooming, selecting, copying, printing, adjusting contrast, coloring, text labeling, measuring length or angles in, scrolling, selecting, adjusting a window or level of, or providing cine functionality for an image.

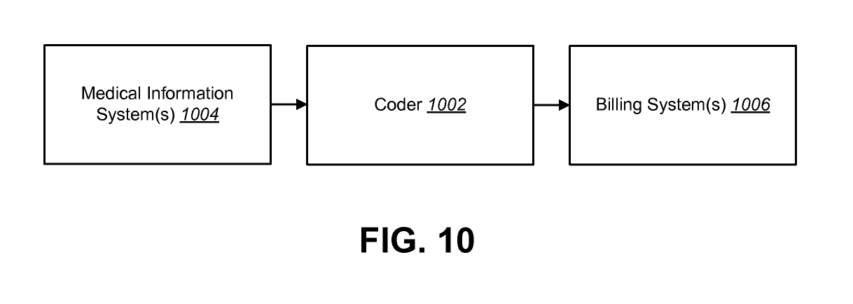

FIG. 10 is a block diagram illustrating one configuration of a coder system. A coder 1002 may be a hardware and/or software module for coding medical data for billing purposes (e.g. in a business environment). The coder 1002 may be connected to one or more medical information system(s) 1004. The coder 1002 may be connected to one or more billing system(s) 1006. Medical information system(s) 1004 may store medical information. For example, medical information system(s) 1004 may store patient demographic information, medical reports, orders for medical procedures, accession numbers, lab test results, medical history, medical images, etc. Patient demographic information may include, for example: patient name, address, telephone number, email address, age, sex, weight, allergies, social security number, insurance information, etc. Medical reports may include, for example, a text report describing a patient's condition and/or treatment, the treating physician, and a treatment date. A medical history may include, for example, previous treatments, current or prior medication prescriptions, etc. Some examples of medical information systems may include Picture Archiving and Communication Systems (PACS), Hospital Information Systems (HIS), Radiology Information Systems (RIS), Clinical Information Systems (CIS), Cardiology Information Systems, Enterprise Data Warehouses (EDW), Laboratory Information Systems (LIS), Voice Recognition Systems, etc. The coder 1002 may receive medical data from the medical information system(s) 1004, code the medical data, and send processed/coded information to the billing system(s) 1006. For example, the coder 1002 may code the data using International Statistical Classification of Diseases and Related Health Problems (ICD) codes. More specifically, the coder 1002 may code the data using ICD-9 (ICD, 9^{th} Revision) codes. The coder 1002 may also code the medical data using Current Procedural Terminology® (CPT®) codes. The coder 1002 may also code the medical data using other medical service and/or medical condition codes. The coder 1002 may maintain dictionaries of terms used by reporting medical personnel (e.g. radiologists) and may map these terms to standard medical service (e.g. CPT®) codes and/or medical condition (e.g. ICD-9) codes. The coder 1002 may automatically assign standard medical service (e.g. CPT®) codes and/or medical condition (e.g. ICD-9) codes to completed medical exams. That is, the coder may automatically code and “auto-complete” charges for billing service transfer.

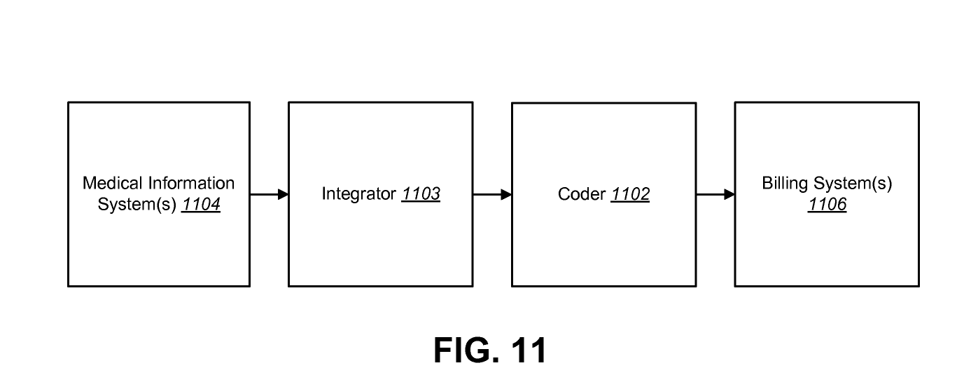

FIG. 11 is a block diagram illustrating another configuration of a coder system. In this configuration, an integrator 1103 may be connected to one or more medical information system(s) 1104. Examples of medical information systems may include a PACS, a RIS, an LIS, a CIS, etc. The integrator 1103 may integrate the information stored on the medical information system(s) 1104. For example, the integrator 1103 may include an integrator DB 230, which may include information from the medical information system(s) 1104. For example, the integrator 1103 DB 230 may include orders (e.g. for medical treatment), medical reports, medical images, institutions, connections, patient demographic information, etc. A coder 1102 may be connected to the integrator 1103. In particular, the coder 1102 may include a DB that is kept updated or synchronized with the integrator 1103 DB 230. In other words, the coder 1102 DB may include (e.g. download) and/or link to data kept on the integrator 1103 DB 230. The coder 1102 may code the medical data and send processed and/or coded information to the billing system(s) 1106.

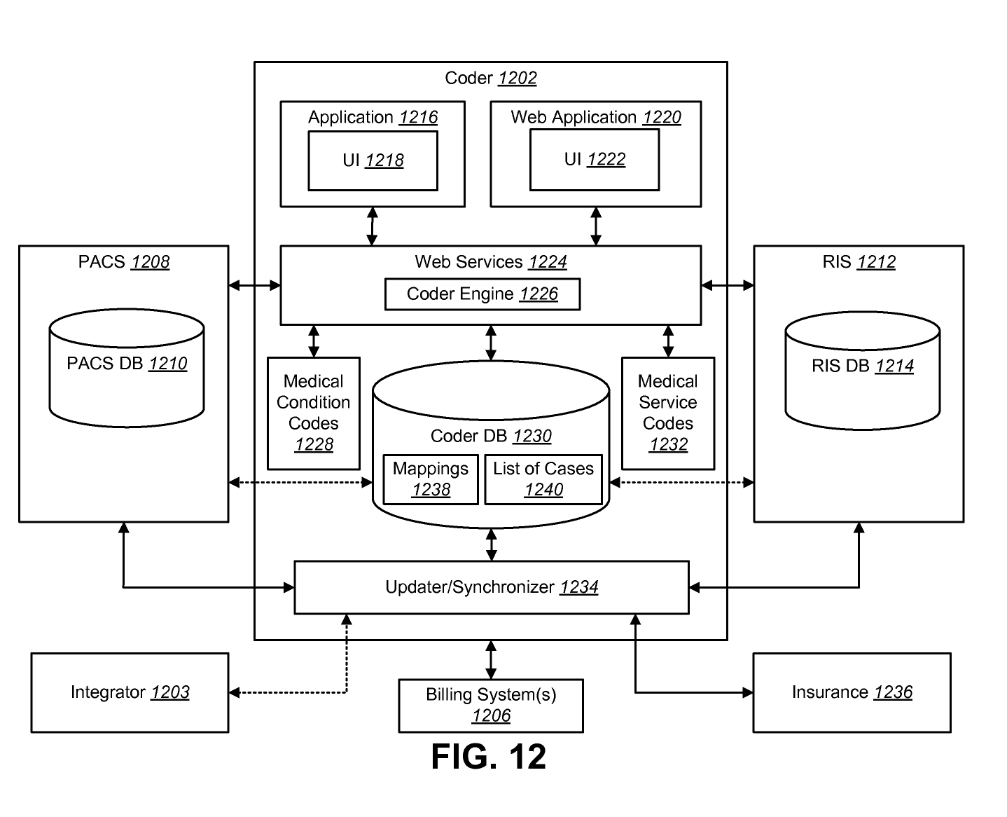

FIG. 12 is a block diagram illustrating one configuration of a coder. The coder 1202 may be connected to one or more medical information system(s). For example, the coder 1202 may be connected to a PACS 1208 and a RIS 1212. The coder 1202 may also be connected to billing system(s) 1206 and an insurance information module 1236. The PACS 1208 may include a PACS DB 1210. The RIS may include a RIS DB 1214. The PACS 1208 may store medical data. For example, the PACS 1208 may store medical images and other data. The RIS 1212 may store medical administrative and other information. For example, the RIS 1212 may store patient demographic information, order information, institution (e.g. hospital, clinic) information, and medical reports, etc. The insurance information module 1236 may provide insurance information for medical service providers (e.g. hospitals, clinics, etc.). The billing system 1206 may be a system that may send, receive, and/or collect bills (e.g. medical bills) or billing information.

The coder 1202 may include an application 1216, a web application 1220, web services 1224, medical condition codes 1228, medical service (e.g. treatment) codes 1232, a coder DB 1230, and/or an updater (e.g. synchronizer) 1234. The coder 1202 may capture cases for billing purposes and support the transfer of coded charge data to the billing system(s) 1206. The coder 1202 may connect to the PACS 1208, RIS 1212, billing system(s) 1206 and insurance information module 1236 locally and/or over a network, such as an intranet or the Internet. The updater 1234 may be a hardware and/or software module.

An updater 1234 may periodically query the PACS DB 1210 and/or the RIS DB 1214 and receive updated information. The updater 1234 may store this information on the coder DB 1230. The updater 1234 may periodically check medical condition codes 1228 and/or medical service codes 1232 for Correct Coding Initiative (CCI) and/or Local Coverage Determination (LCD) edits. The updater 1234 may periodically check for CCI and/or LCD edits over the network. The updater 1234 may be used in conjunction with an integrator 1203. When used in conjunction with an integrator 1103, the updater 1234 may synchronize the coder DB 1230 with the integrator 1203 DB 230. In that case, the integrator 1203 may be connected to the PACS 1208 and RIS 1212. The coder 1202 may obtain medical data from the PACS 1208 and/or RIS via the integrator 1203. Optionally, the updater 1234 may be omitted. In that case, the coder DB 1230 may be built by querying the PACS 1208 and the RIS 1212. For example, the coder DB 1230 may be built using a query of the PACS 1208 (e.g. Dicom^{SM} worklist query) and direct query of the RIS 1212 (e.g. GE® Centricity® RIS).

Medical condition codes 1228 may be codes used in the medical industry for categorizing and/or labeling particular medical conditions. For example, the medical condition codes may be ICD-9 codes. The medical condition codes 1228 may be stored on the coder DB 1230, elsewhere on the coder 1202, or may be stored remotely (e.g. on a device on an intranet or the Internet). The medical service codes 1232 may be codes used in the medical industry for labeling particular medical procedures or treatments. For example, the medical service codes may be CPT® codes. The medical service codes 1232 may be stored on the coder DB 1230, elsewhere on the coder 1202, or may be stored remotely (e.g. on a device on an intranet or the Internet).

The coder DB 1230 may store medical data from the PACS 1208 and the RIS 1212. The coder DB 1230 may store this medical data indirectly via the integrator 1203, or may store it directly from the PACS 1208 and the RIS 1212. The coder DB 1230 may store medical condition codes 1228, medical service codes 1232, and/or code mappings 1238. The coder DB 1230 may also store a comprehensive list of cases 1240 to be coded and billed. The coder DB 1230 may maintain the mappings 1238. The mappings may be dictionaries of terms used by reporting medical personnel (e.g. radiologists) that are mapped to medical condition codes 1228 (e.g. ICD-9 codes) and/or or medical service codes 1232 (e.g. CPT® codes).

The web services 1224 may combine medical data from the PACS 1208 and the RIS 1212 on the coder DB 1230. The web services 1224 may index medical data on the coder DB 1230 according to clinical histories or exam descriptions. The web services 1224 may provide an interface for the application 1216 and the web application 1220 to access and modify coder DB 1230 content. In other words, the web services 1224 may provide the application 1215 (e.g. Windows form application) and the web application 1220 with access to coder DB 1230 elements and may support other server-based functionality. The web services 1224 may allow a user to manually code cases that are not completed automatically. The web services 1224 may launch other coding applications (e.g. Encoder Pro.). The web services 1224 may automatically email coding questions to users (e.g. physicians) who have dictated medical reports. The emails may include screen shots. For example, the coder may obtain additional information from physicians when there is not enough information to reliably code a case. The web services may support importation, processing, and formatting of charge and demographic download files from an institution. The web services 1224 may support the download of demographics and charges to the billing system 1206 (e.g. as formatted text files, direct database download, etc.). For example, the web services 1224 may send demographic and charge information to an Imagine™ billing system 1206. That is, the web services 1224 may interface with one or more billing system(s) 1206. The web services 1224 may also extract data elements from the text of structured reports and automatically populate index tables in the coder DB 1230 with extracted elements.

The web services 1224 may include a coder engine 1226. The coder engine 1226 may automatically code medical data with medical condition codes 1228 and medical service codes 1232. The coder engine 1226 may code the medical data based on order information, medical report information, and code mappings 1238. For example, the coder engine 1226 may assign a medical condition code 1228 and/or a medical service code 1232 to a case stored on the RIS 1212 based on the text of a medical report stored on the RIS, order information stored on the RIS 1212, medical data stored on the PACS 1208 and/or code mappings 1238. The web services 1224 may search and retrieve medical condition codes 1228, medical service codes 1232, and/or code mappings 1238 based on user input.

The application 1216 may include a user interface (UI) 1218. The web application 1220 may include a UI 1222. The UIs 1218, 1222 may provide similar and/or different functionality. The application UI 1218 may provide access to coder 1202 functionality from a local computing device (e.g. desktop computer, laptop, etc.). The web application UI 1222 may provide access to coder 1202 functionality from a computing device that may connect to the web services 1224 via a network (e.g. an intranet or the Internet). The UIs 1218, 1222 may display and be used to modify data (e.g. appropriate table elements) stored on the coder DB 1230, the PACS DB 1210, and/or the RIS DB 1214. The UIs 1218, 1222 may display a list of cases to be coded and billed 1240. The UIs 1218, 1222 may display a history of prior CPT® and ICD-9 codes used. The UIs 1218, 1222 may display the text of an imaging report. The UIs 1218, 1222 may provide a search function to a user (via the web services 1224) for medical condition codes 1228, medical service codes 1232, and code mappings 1238, and may display search results. The UIs 1218, 1222 may also provide a function for a user to launch other coding applications (e.g. Encoder Pro). The UIs 1218, 1222 may provide a function for the addition and deletion of CPT®, ICD-9, modifier codes, and code mappings 1238. For example, a user may add codes to and/or delete codes from a particular case via the UIs 1218, 1222. Furthermore, a user may add, delete, and/or modify medical conditions codes 1228, medical service codes 1232, code mappings 1238, and/or modifier codes via the UIs 1218, 1222. The UIs 1218, 1222 may provide an input function for a user to manually code cases that are not automatically completed and/or billed.

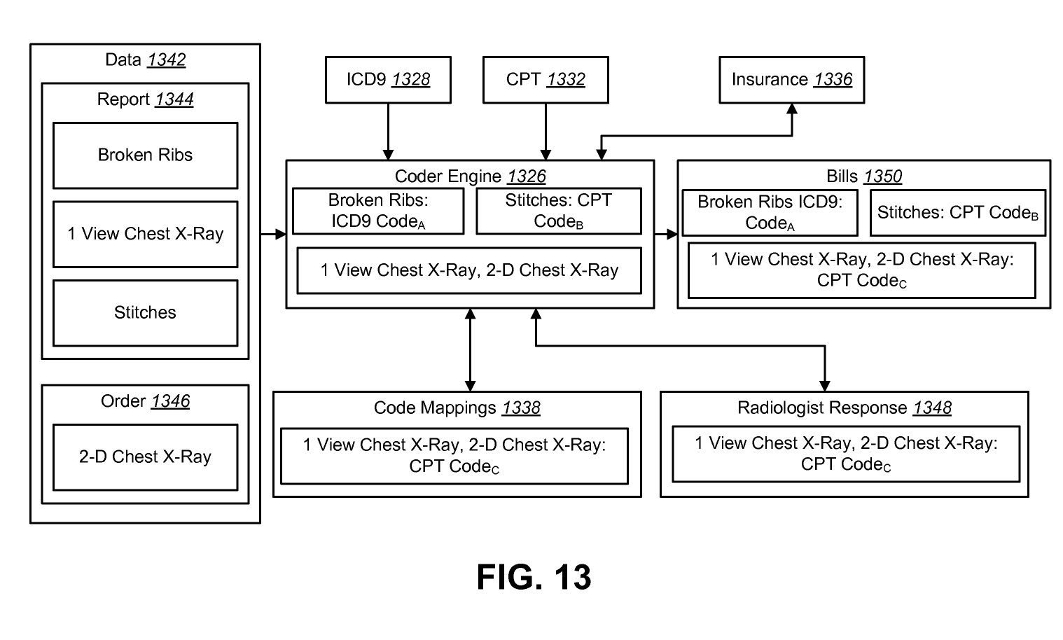

FIG. 13 is a block diagram illustrating one configuration of a coder engine. In particular, FIG. 13 illustrates one example of coder engine 1326 functionality. For example, medical data 1342 may be stored on medical information system(s) 1004. The medical data 1342 may include a medical report 1344 and an order 1346 for a medical procedure (e.g. diagnosis, treatment, etc.). The order 1346 may contain order information. In this example, the order information indicates an order for a “2-D chest x-ray”. The report 1344 may also contain information. In this example, a radiologist reported a “1-view chest x-ray”, diagnosed “broken ribs” and recommended “stitches” for treatment. The coder engine 1326 may receive the report 1344 data and the order 1346 data. The coder engine 1326 may receive medical coding information from an ICD-9 dictionary 1328 and a CPT® 1332 dictionary. The coder engine 1326 may also receive code mappings 1338. The coder engine 1326 may attempt to match the “broken ribs”, “1-view chest x-ray”, “stitches” and “2-D chest x-ray” with appropriate ICD-9 1328 and CPT® 1332 codes. In this example, the coder engine may find an exact match for “broken ribs” from the ICD-9 code dictionary. The coder engine may thus assign an ICD-9 Code_{A} to the “broken ribs” data. The coder engine may also find an exact match for “stitches” in the CPT® 1332 code dictionary. The coder engine may thus assign a CPT® Code_{B} to the “stitches” data. However, the coder engine may find that “1-view chest x-ray” and “2-D chest x-ray” do not match each other. Thus, the coder engine 1326 may send data for a radiologist response 1348. The radiologist may view the “1-view chest x-ray” and “2-D chest x-ray” along with case information and decide that the case should be mapped to CPT® Coder. The coder engine 1326 may receive the radiologist response and store the mapping with the code mappings 1338. In other words, the coder engine 1326 may map “1-view chest x-ray” and “2-D chest x-ray)” (and/or the combination) to a CPT® Coder. The case may thus be coded with a CPT®Code_{C}. The coder engine 1326 may also receive insurance information 1336. The insurance information may be accessed in an automated fashion or manually entered. Once the coder engine 1326 has coded all of the medical conditions and/or procedures and has received the insurance information, the coder engine may produce bills or billing data 1350. The coder engine 1326 may send the bills or billing (e.g. “coded”) data to a recipient and/or billing system. If a similar case arises in the future where an order calls for a “2-D chest x-ray” and the report states a “1-view chest x-ray”, the coder engine 1326 may read the mapping from the code mappings 1338, automatically code the case, and produce a bill 1350 and/or send the coded information to a billing system.

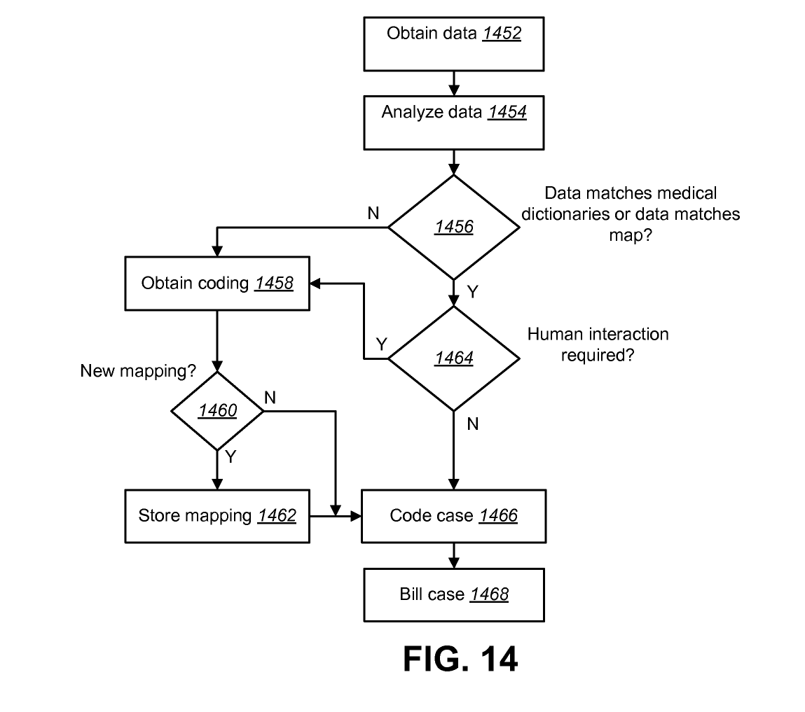

FIG. 14 is a flow diagram illustrating a method for coding medical data. A coder 1002 may obtain 1452 data. For example, the coder 1002 may query and/or receive information from an integrator 1103 and/or medical information systems 1004 (e.g. a PACS 1208 and a RIS 1212). For example, the coder 1002 may obtain 1452 order, report, and other information from a RIS 1212 and a PACS 1208. The coder 1002 may analyze 1454 the data. For example, the coder 1002 may search the order information and report text information for medical condition and/or medical service (e.g. treatment) information. The coder 1002 may also compare the medical data with medical condition codes 1228 and medical service codes 1232 (e.g. ICD-9 codes and CPT® codes).

The coder 1002 may determine 1456 whether the medical data matches medical condition codes 1228, medical service codes 1232 and/or whether the data matches a map 1238. For example, the coder 1002 may search for different phrases specifically defined by a syntax (e.g. mappings 1238). If the data does not match the medical condition codes 1228, does not match the medical service codes 1232 and does not match a map 1238, then the coder 1002 may obtain 1458 coding. For example, the coder 1002 may notify a user (e.g. radiologist, medical personnel, etc.) that coding is needed. The coder 1002 may also provide suggestions (e.g. partial coding matches) of possible codes to the user. The user may input a coding for the medical data. The coder 1002 may thus obtain 1458 a coding as determined by the user. The coder 1002 may determine 1460 whether the coding of the medical data is a new mapping. For example, the coder 1002 may compare the coding of the medical data with medical data code mappings 1238 stored on the coder DB 1230. If the mapping is not a new mapping (e.g. if it is already stored in the code mappings 1238), the coder 1002 may code 1466 the case. For example, the coder 1002 may associate the medical data with medical condition codes 1228 (e.g. ICD-9 codes), and/or medical service codes 1232 (e.g. CPT® codes) according to a code match, a code mapping, and/or a user-specified code, as applicable. The coder 1002 may bill 1468 the case. For example, the coder 1002 may generate an invoice or bill to send to the recipient of medical services or the recipient's insurance company. Alternatively, the coder 1002 may bill 1468 the case by sending the coded data to a billing system. If the code mapping is a new mapping, the coder 1002 may store 1462 the mapping with the code mappings 1238 in the coder DB 1230. The coder 1002 may then code 1466 and bill 1468 the case.

If the data matches medical condition codes 1228, medical service codes 1232, and/or a code mapping 1238, the coder 1002 may determine 1464 whether human interaction is required. For example, a user may flag certain cases, condition codes 1228, service codes 1232 and/or code mappings 1238 for user interaction or verification. If human interaction is required, the coder 1002 may obtain 1458 a coding. The coder 1002 may notify a user that the data coding needs verification and/or coding. The coder 1002 may also provide suggestions to the user, such as coding or mapping matches and/or partial matches, for example. The coder 1002 may determine 1460 whether the coding of the medical data is a new mapping. If it is not a new mapping, the coder may code 1466 and bill 1468 the case. If it is a new mapping, the coder 1002 may store 1462 the new mapping, code 1466 and bill 1468 the case. If human interaction is not required, the coder 1002 may code 1466 the medical data (e.g. case). For example, the coder 1002 may associate the medical data with matching, mapped, and/or user-specified medical condition or service codes (e.g. ICD-9, CPT® codes respectively). The coder 1002 may bill 1468 the case.

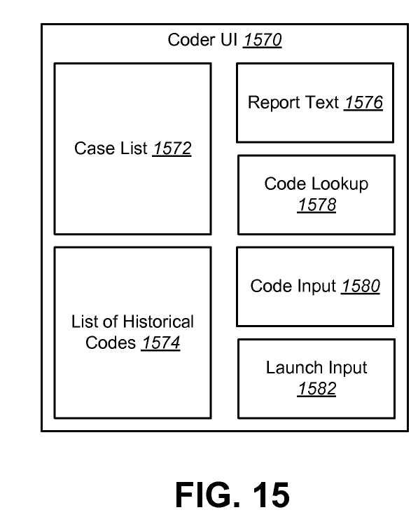

FIG. 15 is a block diagram illustrating a coder UI 1570. A coder 1202 may provide a coder UI 1570. For example, the coder UI 1570 may be provided on an application 1216 and/or a web application 1220. The coder UI 1570 may provide access to coder 1202 functionality. The coder UI 1570 may be used for manual coding of cases that do not auto-complete. The coder UI 1570 may include a case list 1572. The case list 1572 may be a comprehensive list of cases to be coded and billed. For example, the case list 1572 may display cases where case medical data did not match medical condition codes 1228 (e.g. ICD-9), medical service codes 1232 (e.g. CPT®), and/or code mappings 1238. The case list 1572 may also display cases that require coding verification. The case list 1572 may also provide case selection functionality (e.g. a user may select a particular displayed case). The coder UI 1570 may include a list of historical and/or suggested codes 1574 corresponding to a case selected in the case list 1572. The list of historical or suggested codes 1574 may provide a history of prior medical condition (e.g. ICD-9) codes 1228 and/or medical service (e.g. CPT®) codes 1232 used. For example, the coder 1202 may display codes that have been associated with cases having similar medical data. More specifically, the coder 1202 may display codes that have matched (or been mapped) to cases with similar medical report, order, or other data. Alternatively or in addition, the list of historical codes 1574 may be a listing of codes used on earlier diagnoses, treatments, etc. for the same patient.

The coder UI 1570 may display report text 1576. For example, the coder UI 1576 may display the text of a medical (e.g. imaging) report corresponding to a case selected in the case list 1572. The coder UI 1570 may also include a code look-up module 1578. For example, a user may use the code look-up module to find medical condition codes (e.g. ICD-9) and/or medical service codes (e.g. CPT®) from a dictionary. For example, a user may view and select codes from an index of codes displayed by the code look-up module 1578. Alternatively, the code look-up module 1578 may display codes resulting from a user-specified search. The results may be code (e.g. ICD-9, CPT®, etc.) and/or mapping matches.

The coder UI 1570 may include a code input module 1580. The code input module 1580 may include one or more input controls (e.g. text boxes, buttons, radio buttons, check boxes, drop-down lists, etc.). The code input module 1580 may receive codes inputted by a user. The code input module 1580 may also allow a user to add or delete medical condition codes (e.g. ICD-9), medical service codes (e.g. CPT®), modifier codes, and/or mappings. The code input module 1580 may receive and display codes selected by a user in the list of historical codes 1574 and/or the code look-up 1578. The coder UI 1570 may also include a launch input 1582. The launch input 1582 may be a control (e.g. button, check box, etc.). For example, the launch input 1582 may support a context-specific launch of other coding applications when clicked. For example, when a user clicks the launch input 1582, the coder 1202 may launch Encoder Pro® and load data into Encoder Pro® such that it may facilitate coding.

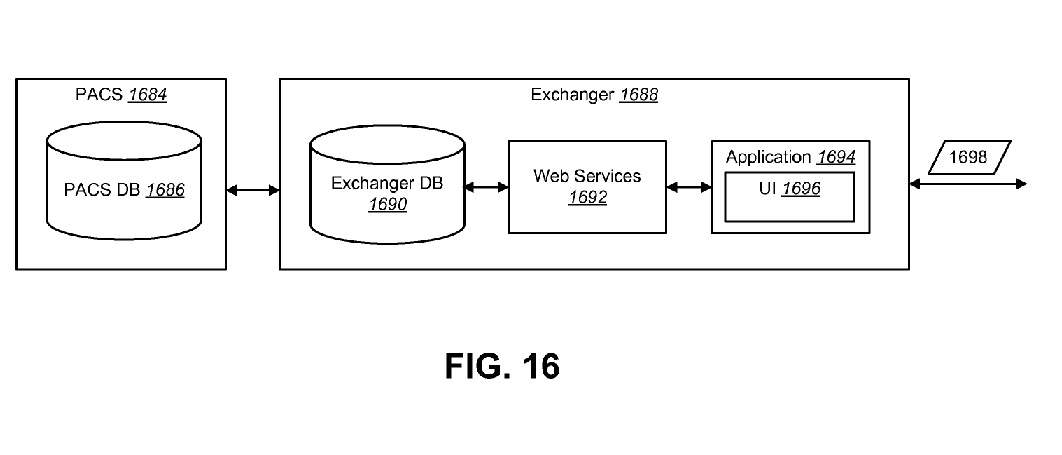

FIG. 16 is a block diagram illustrating one configuration of an exchanger 1688. The exchanger 1688 may be a hardware and/or software module for securely transferring medical data over a network. For example, the exchanger 1688 may securely transfer imaging data from one institution (e.g. hospital, clinic, etc.) to another. The exchanger 1688 may also support publishing, retrieval, and display of medical imaging reports. The exchanger 1688 may be connected to one or more medical information systems 1684. Although the exchanger 1688 is illustrated as being connected to a single PACS 1684 for clarity, the exchanger 1688 may connect to one or more medical information systems 1684 (e.g. RIS, LIS, CIS, EDW, etc.). The PACS 1684 may include a PACS DB 1686. The PACS DB 1686 may store medical data. In particular, the PACS DB 1686 may store medical images and associated data. For example, the PACS DB 1686 may be an SQL DB and may store Dicom^{SM} files. The exchanger 1688 may include an exchanger DB 1690, web services 1692 and an application 1694. The exchanger DB 1690 may include and/or link to portions of or all of the data stored on the PACS DB 1686. The exchanger DB 1690 may also store user information and group information (e.g. authorization information). The web services 1692 may provide an interface between the application 1694 and the exchanger DB 1690. The web services 1692 may also provide other server-based processing. The application 1694 may provide a user access to exchanger 1688 functionality. The application 1694 may include a UI 1696. The UI 1696 may provide an interface for users to control their own contact and personal security information. The exchanger 1688 may allow users to list, retrieve, and/or display only those medical cases that they are authorized to access.

The exchanger 1688 may access, format, and/or transfer data stored in the PACS DB 1686. More specifically, the web services 1692 may format and encrypt medical data for transfer. The encrypted medical data 1698 may be transferred to a publishing system and/or other exchanger modules. For example, the exchanger 1688 may allow users to import images via a direct Dicom^{SM} query. The exchanger 1688 may also allow users to retrieve information from the PACS 1684. The exchanger 1688 may import images in varying formats (e.g. jpg, bmp, tif, gif, png, Dicom^{SM}, etc.) from connected drives and other media (e.g. Dicom^{SM} CD-ROMs, DVDs, Blu-Ray discs, etc.). The exchanger 1688 may also convert non-Dicom^{SM} images into Dicom^{SM} format and designate the images as secondary capture images.

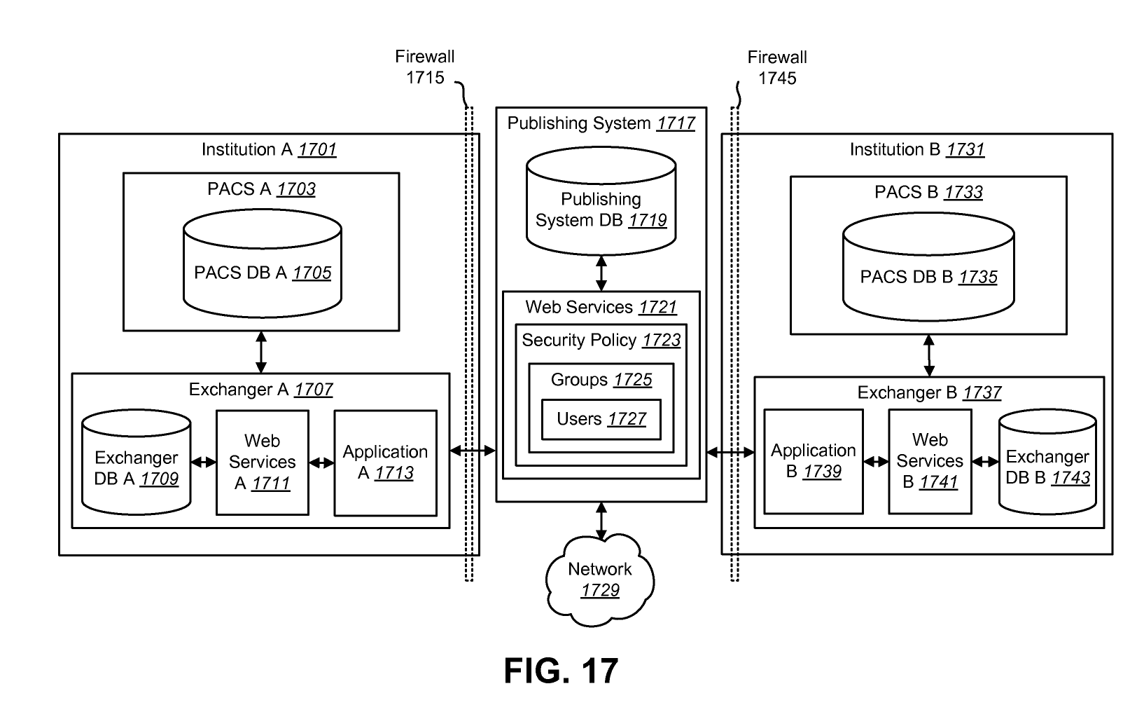

FIG. 17 is a block diagram illustrating one configuration of an exchanger and publishing system. A publishing system 1717 may be a system for securely transferring and/or publishing medical data. The publishing system 1717 may be connected to an institution A 1701 and an institution B 1731. Institution A 1701 may include a PACS A 1703 and an exchanger A 1707. The PACS A 1703 may include a PACS DB A 1705. The exchanger A 1707 may include an exchanger DB A 1709, web services A 1711, and an application A 1713. Communications between institution A 1701 and the publishing system 1717 may be secured by a firewall 1715. Institution B 1731 may include a PACS B 1733 and an exchanger B 1737. The PACS B 1733 may include a PACS DB B 1735. The exchanger B 1737 may include an exchanger DB B 1743, web services B 1741, and an application B 1739. Communications between institution B 1731 and the publishing system 1717 may also be secured by a firewall 1745. For example, data that is transferred from institution A 1701 and/or institution B 1731 may be formatted into a byte stream, encrypted, and sent on port 8080. Alternatively, the exchanger A 1707 and/or exchanger B 1737 may employ the secure socket layer (SSL) protocol for transmission through their respective firewalls 1715, 1745. For example, all exchanges of confidential user and patient information may be encrypted.

The exchanger A 1707 may obtain information or medical data from the PACS A 1703 (or other medical information system). That is, the exchanger A 1707 may download information from the PACS DB A 1705 and/or link to information on the PACS DB A 1705. The exchanger A 1707 may format the data into a byte stream. The exchanger A 1707 may encrypt the byte stream. The exchanger A 1707 may also obtain group and/or user rights and associate those rights to the data. The exchanger A 1707 may send the encrypted byte stream and the associated group and/or user rights to the publishing system 1717. The information may be sent on port 8080.

The publishing system 1717 may include a publishing system DB 1719 and publishing system web services 1721. The publishing system DB 1719 may store medical data. For example, the publishing system DB 1719 may store medical imaging data from the PACS A 1703 and/or PACS B 1733 with or without encryption. The publishing system DB 1719 may also store authorization information for groups 1725 and/or users 1727. The publishing system web services 1721 may facilitate the transfer of medical data from one institution (e.g. institution A 1701) to another (e.g. institution B 1731). The publishing system may be connected to a network 1729 (e.g. an intranet or the Internet). The publishing system 1717 may support publishing from Dicom^{SM} and non-Dicom^{SM} sources. The publishing system 1717 may also support several types of publishing. For example, the publishing system 1717 may support simple case archival, consultation request, and/or teaching file publishing.

The publishing system web services 1721 may include a security policy 1723. The security policy 1723 may include groups 1725 (e.g. group data), which may include users 1727 (e.g. user data). The security policy 1723 may allow only groups 1725 and/or users 1727 that have been specifically authorized to access certain medical data (e.g. images) stored on the publishing system DB 1719. For example, a user publishing certain images from institution A 1701 may authorize a group 1725 to access those images on the publishing system DB 1719. For example, all data publishing may be controlled by user rights to publish in a source group 1725 name and publish to a recipient group 1725.

The exchanger B 1737 may request medical data stored on the publishing system 1717. If the requesting group and/or user is authorized, the publishing system 1717 may send the requested medical data to the exchanger B 1737. The publishing system 1717 may also send group and/or user rights (e.g. associated with the medical data) to the exchanger B 1737. The exchanger B 1737 may receive the medical data and rights from the publishing system 1717. The exchanger B 1737 may receive the information on port 8080. If the medical data is encrypted, the exchanger B 1737 may decrypt the medical data. The exchanger B 1737 may reconstitute the medical data (e.g. from a byte stream) for viewing and/or storage. The exchanger B 1737 may store the data on the exchanger DB B 1743 and/or export it to the PACS DB B 1735.

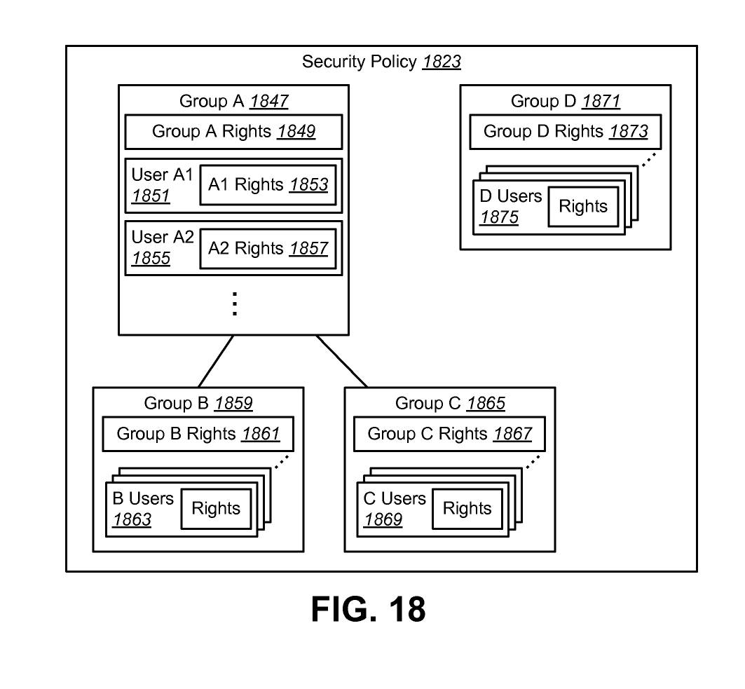

FIG. 18 is a block diagram illustrating one example of a security policy 1823. The security policy 1823 may be a policy designed to allow specific groups or users access to specific data. The security policy 1823 may include groups. For example, the security policy 1823 may include a group A 1847, group B 1859, group C 1865, and group D 1871. Groups may include group rights. For example, group A 1847 may have group A rights 1849, group B 1859 may have group B rights 1861, group C 1865 may have group C rights 1867, and group D 1871 may have group D rights 1873. Each group's rights may be the same or distinct. Groups may include users. For example, group A 1847 may include user A1 1851 and user A2 1855. Group A may also include other users. Furthermore, group B 1859 may include B users 1863, group C 1865 may include C users 1869, and group D 1871 may include D users 1875. Users may include rights. For example, user A1 may include A1 rights 1853 and user A2 1855 may include A2 rights 1857. For example, A1 rights 1853 and A2 rights 1857 may include or inherit group A rights 1849. However, A1 rights 1853 and A2 rights 1857 may be the same as or distinct from each other. Furthermore, B users 1863, C users 1869, and D users 1875 may all include rights. Group and user rights may determine which medical data stored on the publishing system DB 1719 a group or user may view and/or transfer (e.g. upload/download).

Groups may be organized in a hierarchical manner. For example, group A 1847 may be a parent group to child group B 1859 and child group C 1865. The security policy 1823 may allow authorized users to create and/or manage user groups. For example, user A11851 may create and/or manage group B 1859. This authorization may allow a user to include (or exclude) users in groups and control user rights to upload cases to and/or download cases from the publishing system DB 1619. This authorization may also allow a user to manage groups. For example, user A11851 may include users in or exclude users from group B. However, user A1 may not include users in nor exclude users from group D 1871. Users may be designated as group managers. Group managers may automatically have management rights to child groups. For example, if user A1 1851 were designated a group manager, user A1 1851 may create a child group C 1865. In that case, user A1 1851 may also designate one of the C users 1869 as a child group manager.

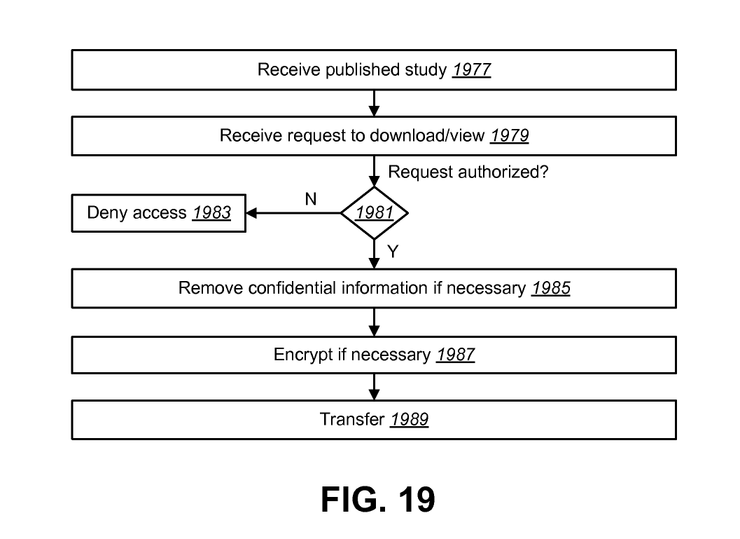

FIG. 19 is a flow diagram illustrating one method for publishing medical data. A publishing system 1717 may receive 1977 a published study. For example, exchanger A 1707 may receive a Dicom^{SM} image file from the PACS A 1703, remove confidential information if necessary, convert the file to a byte stream, encrypt the byte stream, and send the byte stream on port 8080 to the publishing system 1717. The exchanger A 1707 may also send associated group or user rights with the file. The publishing system 1717 may receive 1977 the published study and store it on the publishing system DB 1719. The publishing system 1717 may send an email to or otherwise notify one or more intended recipients associated with the published study. For example, if the published study is a consulting request, the exchanger A 1707 and/or publishing system 1717 may assign consultants and automatically send an email notification to the assigned consultants. Furthermore, the exchanger A 1707 and/or publishing system 1717 may automatically send an email notification to the sender of the consultation request when a consult report is created or modified.

The publishing system 1717 may receive 1979 a request to download and/or view the published study. The publishing system 1717 may determine 1981 whether the request is authorized. For example, the publishing system 1717 may determine 1981 whether the requesting user has either user rights and/or group rights that may allow the user to view and/or download the data. If the user does not have adequate user rights or group rights, the publishing system 1717 may deny 1983 access to the requesting user.

The publishing system 1717 may remove 1985 confidential information if necessary. For example, if the published study is a teaching file and the requesting user only has rights to view and/or download non-confidential information, the publishing system 1717 may remove confidential information (e.g. Dicom^{SM} header or patient demographic information). Optionally, the exchanger A 1707 may remove confidential information before publishing the medical data to the publishing system 1717. The publishing system 1717 may encrypt 1987 the medical data if necessary. For example, if the data is stored on the publishing system DB 1719 in an unencrypted format, or if the publishing system 1717 decrypted the data in order to remove or format some information, the publishing system 1717 may encrypt 1987 the data. The publishing system 1717 may also transfer 1989 the data to the requesting user if the user has appropriate download rights. Otherwise, the publishing system 1717 may only allow a user to view, but not download the medical data.

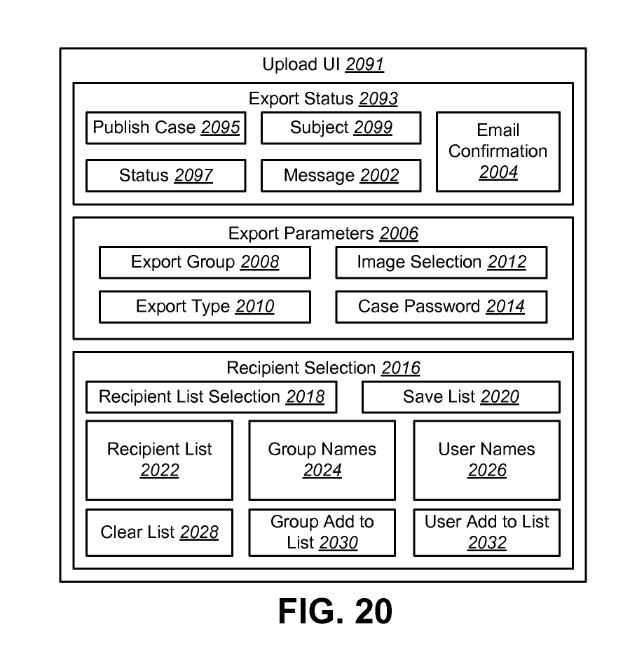

FIG. 20 is a block diagram illustrating a user interface. The upload UI 2091 may be a UI used to access exchanger functionality. The upload UI 2091 may include an export status module 2093, an export parameters module 2006 and/or a recipient selection module 2016. The export status module 2093 may include a publish case input 2095, a status display 2097, an email confirmation input 2004, a subject input 2099 and a message input 2002. The publish case input 2095 (e.g. button, etc.) may initiate a publishing function on the exchanger 1688 when clicked. That is, when a user clicks the publish case input 2095, the exchanger may publish (e.g. upload) selected cases on a publishing system 1717. The status display 2097 may display the current status of a case. For example, the status display 2097 may display “not published”, “unpublished”, “in process”, “transferring”, “publishing”, “published”, “finished”, etc. This may indicate whether a case (or study) has been published to the publishing system 1717 or is still in process. The email confirmation input 2004 may be a control (e.g. button, check box, radio button, text box, etc.) that may be used to send or select an email confirmation. The email confirmation input 2004 may initiate an email confirmation to the publisher and/or recipient(s) of a case. Alternatively, the email confirmation input 2004 may be used to select that an email confirmation associated with a published case or study be sent to the publisher and/or recipient(s) of the case. For example, when a case is published (e.g. it is available on the publishing system), an email confirmation may be sent to the publisher (i.e. user who initiated the publication of the case) and/or recipient(s) (i.e. users who are intended to have access to the case) when email confirmation has been selected. The subject input 2099 may be a control (e.g. text box, drop-down list, etc.) where a user may input a subject for a confirmation email to be sent to the case publisher and/or recipient(s). The message input 2002 may be a control (e.g. text box, drop-down list, etc.) where a user may input a confirmation email message to be sent to the case publisher and/or recipient(s).

The export parameters module 2006 may include an export group input 2008, export type input 2010, image selection input 2012, and case password input 2014. The export group input 2008 may be a control (e.g. drop-down list, text box, radio button(s), check box(es), etc.) where a user may input and/or select the entity that is publishing the case or study. For example, the export group input 2008 may be a drop-down list containing the names of several medical facilities or groups (e.g. Intermountain Health Care, University Hospital, etc.) where a user may designate the entity that is exporting or publishing the case. The export type input 2010 may be a control (e.g. drop-down list, text box, radio button(s), check box(es), etc.) that may be used to input or select a type of export. For example, the export type input 2010 may be a drop-down list containing several options which may include case publication (e.g. archival), consultation request, and teaching files. These options may control how the case is exported. For example, if “consultation request” is selected, an email notification to one or more consulting physician(s) may be sent when it is published. Furthermore, an email notification may also be sent to the publisher when a consulting report is created and/or modified. The options contained in the export type input 2010 may also include one or more options where protected health information (PHI) may be removed. For example, when “teaching file” is selected, PHI may be removed from the case when it is published. The options contained in the export type input 2010 may also include options where PHI is not removed. Additionally, when a case is published, key words may be added to a case for searching.

The image selection input 2012 may be a control (drop-down list, radio button(s), check box(es), text box, etc.) where a user may designate an image or images to be published with the case. For example, the image selection input 2012 may be a drop-down list containing options to export “Selected Images”, “Current Image”, “Current Series”, or “Current Study”. Thus, a user may select one or more images for export, whether they be selected images, an image being currently (or most recently) viewed, a current series of images, or all of the images in the current study. The case password input 2014 may be a control (e.g. text box, drop-down list, radio button(s), check box(es), etc.) where a user may designate a password to be associated with the case to be published. For example, a publisher may desire another layer of security before a recipient may access the contents of a case. The publisher may use the case password input 2014 to designate a password associated with the case such that a recipient (or other user) will not be able to access the contents of the case without the password.

The recipient selection module 2016 may include a recipient list selection input 2018, a save list input 2020, a recipient list 2022, a clear list input 2028, a group names list 2024, a group add to list input 2030, a user names list 2026, and a user add to list input 2032. The recipient list selection input 2018 may be a control (e.g. drop-down list, text box, radio button(s), check box(es), etc.) where a user may designate or select recipients (i.e. groups and/or users that may access a published case). For example, the recipient list selection input 2018 may be a drop-down list that may display previously saved recipient lists such that a user may select one of the recipient lists for publication. The save list input 2020 may be a control (e.g. button, etc.) where a user may save a list of recipients (e.g. groups and/or users) that may be currently displayed in the recipient list 2022. For example, a recipient list that is currently displayed in the recipient list 2022 when a user clicks the save list input 2020 may be saved and displayed in the recipient list selection input 2018 for later selection and/or use. The recipient list 2022 may be a control (e.g. text box, list, table, etc.) where groups and/or users may be displayed. The recipient list 2022 may display both a recipient name and a recipient type. For example, if Intermountain Healthcare and Dr. X were displayed in the recipient list 2022, the recipient list 2022 may also display that Intermountain Healthcare is a “group”, while Dr. X is a “user”. The clear list input 2028 may be a control (e.g. button, etc.) where a user may clear the recipient list 2022. For example, a user may select one or more recipients in the recipient list 2022 and clear or delete them from the list by clicking the clear list input 2028.

The group names list 2024 may be a control (e.g. text box, list, table, etc.) which may display and allow a user to select groups to publish to. A user may also use the group add to list input 2030 to add selected groups in the group names list 2024 to the recipient list 2022. For example, the group names list 2024 may include institutions or groups of users such as “Intermountain Health Care”, “Alta View Hospital”, “Cottonwood Hospital”, “LDS Hospital”, “Primary Children's Hospital”, etc. A user may select one or more of these groups and click the group add to list input 2030 to add the selected group(s) to the recipient list 2022. The user names list 2026 may be a control (e.g. text box, list, table, etc.) which may display and allow a user to select users to publish to. A user may also use the user add to list input 2032 to add selected users in the user names list 2026 to the recipient list 2022. For example, the user names list 2026 may include individual users such as “Dr. X”, “Dr. Y”, “Dr. Z”, etc. A user may select one or more of these users and click the user add to list input 2032 to add the selected user(s) to the recipient list 2022.

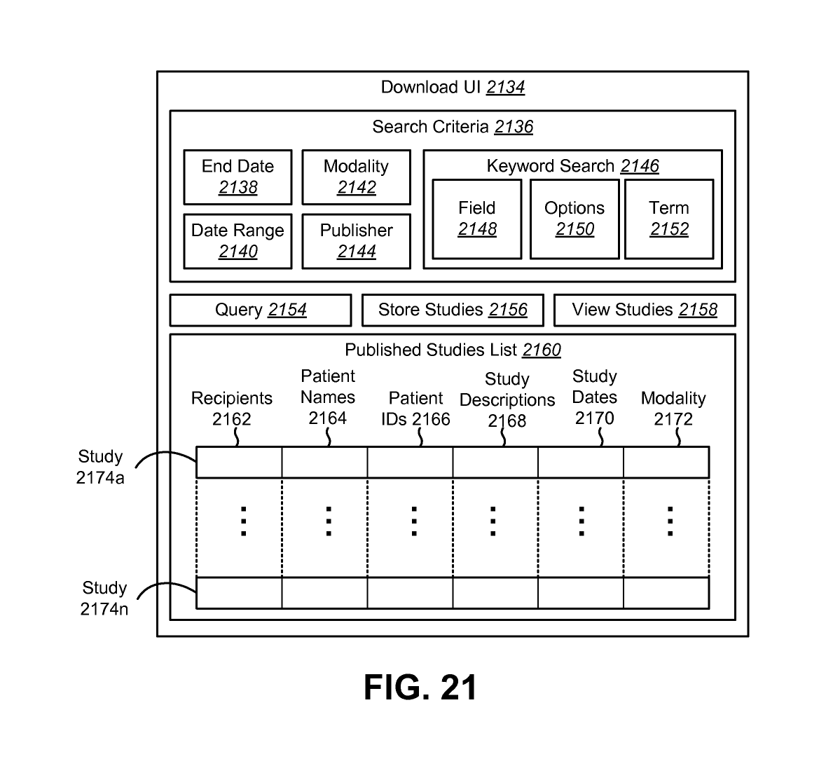

FIG. 21 is a block diagram illustrating a user interface. The download UI 2134 may be a user interface where a user may search for, view, and/or download studies. The download UI 2134 may include a search criteria module 2136 and a published studies list 2160. The download UI 2134 may also include a query input 2154, store studies input 2156, and a view studies input 2158. The search criteria module 2136 may include an end date input 2138, a date range input 2140, a modality input 2142, a publisher input 2144 and a keyword search module 2146. The end date input 2138 may be a control (e.g. drop-down list, text box(es), calendar, etc.) where a user may designate an end date as a search criterion. For example, a user may specify a search for cases that occurred (e.g. were captured, dictated, published, entered, etc.) before a certain date. The date range input 2140 may be a control (e.g. drop-down list, text box(es), calendar(s), etc.) where a user may specify a search for cases that occurred (e.g. were captured, dictated, published, entered, etc.) within a certain date range. For example, a user may specify a number of days, weeks, months, or years before an end date in which to search. The modality input 2142 may be a control (e.g. drop-down list, text box, radio button(s), check box(es), etc.) where a user may specify or select a modality (e.g. All, X-ray, MRI, CT, etc.) as a search criterion. The publisher input 2144 may be a control (e.g. drop-down list, text box, radio button(s), check box(es), etc.) where a user may specify a search for cases that were published (e.g. exported) by a particular entity (e.g. All, hospital name, clinic name, individual name, etc.).

The keyword search module 2146 may include a field input 2148, an options input 2150, and a term input 2152. The field input 2148 may be a control (e.g. drop-down list, text box, radio button(s), check box(es), etc.) where a user may specify a particular field for case searching. For example, a user may specify a search within a field such as “Patient Name”, Patient ID Number”, “Patient Gender”, “Medical Report”, etc. of the cases available on the publishing system. The options input 2150 may be a control (e.g. drop-down list, text box, radio button(s), check box(es), etc.) where a user may specify particular options that may depend on the field input 2148. For example, if a user has chosen a “Patient Name” search in the field input 2148, then the options input 2150 may include options such as “Begins With”, “First Name Only”, “Last Name Only”, “Case Sensitive”, “Whole Names Only”, “Similar Names”, etc. Also, if a user has chosen a “Medical Report” search in the field input 2148, then the options input 2150 may include options such as “Whole Words Only”, “Case Sensitive”, “Natural Language”, etc. Many other variations may be apparent to one skilled in the art. The term input 2152 may be a control (e.g. text box, drop-down list, etc.) where a user may specify a search term. For example, a user may enter a patient name, patient ID number, medical terms, or other characters (e.g. partial or complete words, phrases, etc.) in the term input 2152 for searching. The query input 2154 may be a control (e.g. button, etc.) where a user may initiate a search. For example, a user may click the query input 2154 to initiate a search on the publishing system 1717 according to any of the designated criteria in the search criteria module 2136. The store studies input 2156 may be a control (e.g. button, etc.) where a user may initiate a download and/or storage of one or more selected studies. The view studies input 2158 may be a control (e.g. button, etc.) where a user may initiate a display of (e.g. open an application or viewer to view) one or more selected studies.

The published studies list 2160 may be a control (e.g. table, text box, list, etc.) that may display and/or allow the selection of one or more studies 2174a-n. The published studies list 2160 may include one or more columns of information or data. For example, the published studies list 2160 may display recipient(s) 2162, patient name(s) 2164, patient ID number(s) 2166, study description(s) 2168, study date(s) 2170, and/or modality 2172, etc. More columns of information may be apparent to one skilled in the art. The published studies list 2160 may display those studies that match the criteria selected in the search criteria module 2136. For example, a user may specify several search criteria in the search criteria module 2136 and click the query input 2154. The published studies list 2160 may then display the studies that match the user-specified criteria (i.e. search results). The published studies list 2160 may also allow a user to select one or more studies 2174a-n for viewing or download.

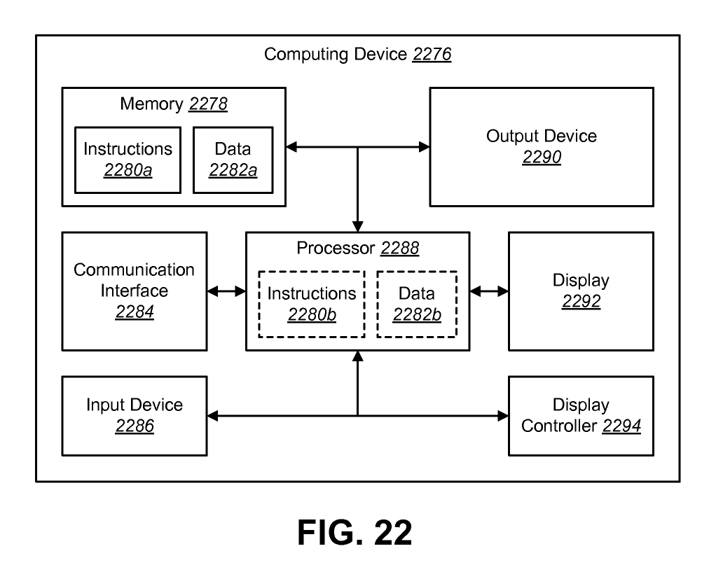

FIG. 22 illustrates various components that may be utilized in a medical information system, an integrator, a coder, an exchanger, and/or a publishing system. A medical information system, an integrator, a coder, an exchanger, and/or a publishing system may each be a computing device 2276. The illustrated components may be located within the same physical structure or in separate housings or structures.

The computing device 2276 may include a processor 2288 and memory 2278. The processor 2288 controls the operation of the computing device 2276 and may be embodied as a microprocessor, a microcontroller, a digital signal processor (DSP) or other device known in the art. The memory 2278 may include instructions 2280a and data 2282a. The processor 2288 typically performs logical and arithmetic operations based on program instructions 2280a and data 2282a stored within the memory 2278. That is, instructions 2280b and data 2282b may be stored and/or run on the processor 2288.

The computing device 2276 typically may include one or more communication interfaces 2284 for communicating with other electronic devices. The communication interfaces 2284 may be based on wired communication technology, wireless communication technology, or both. Examples of different types of communication interfaces 2284 include a serial port, a parallel port, a Universal Serial Bus (USB), an Ethernet adapter, an IEEE 1394 bus interface, a small computer system interface (SCSI) bus interface, an infrared (IR) communication port, a Bluetooth wireless communication adapter, and so forth.

The computing device 2276 typically may include one or more input devices 2286 and one or more output devices 2290. Examples of different kinds of input devices 2286 include a keyboard, mouse, microphone, remote control device, button, joystick, trackball, touchpad, lightpen, etc. Examples of different kinds of output devices 2290 include a speaker, printer, etc. One specific type of output device which may be typically included in a computer system is a display device 2292. Display devices 2292 used with embodiments disclosed herein may utilize any suitable image projection technology, such as a cathode ray tube (CRT), liquid crystal display (LCD), light-emitting diode (LED), gas plasma, electroluminescence, or the like. A display controller 2294 may also be provided for converting data stored in the memory 2278 into text, graphics, and/or moving images (as appropriate) shown on the display device 2292.

Of course, FIG. 22 illustrates only one possible configuration of a hospital information system, an integrator, a coder, an exchanger, and/or a publishing system. Various other architectures and components may be utilized.

Information and signals may be represented using any of a variety of different technologies and techniques. For example, data, instructions, commands, information, signals, bits, symbols, and chips that may be referenced throughout the above description may be represented by voltages, currents, electromagnetic waves, magnetic fields or particles, optical fields or particles, or any combination thereof.

The various illustrative logical blocks, modules, circuits, and algorithm steps described in connection with the embodiments disclosed herein may be implemented as electronic hardware, computer software, or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present invention.

The various illustrative logical blocks, modules, and circuits described in connection with the embodiments disclosed herein may be implemented or performed with a general purpose processor, a digital signal processor (DSP), an application specific integrated circuit (ASIC), a field programmable gate array signal (FPGA) or other programmable logic device, discrete gate or transistor logic, discrete hardware components, or any combination thereof designed to perform the functions described herein. A general purpose processor may be a microprocessor, but in the alternative, the processor may be any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration.

The steps of a method or algorithm described in connection with the embodiments disclosed herein may be embodied directly in hardware, in a software module executed by a processor, or in a combination of the two. A software module may reside in RAM memory, flash memory, ROM memory, EPROM memory, EEPROM memory, registers, hard disk, a removable disk, a CD-ROM, or any other form of storage medium known in the art. An exemplary storage medium is coupled to the processor such that the processor can read information from, and write information to, the storage medium. In the alternative, the storage medium may be integral to the processor. The processor and the storage medium may reside in an ASIC. The ASIC may reside in a user terminal. In the alternative, the processor and the storage medium may reside as discrete components in a user terminal.

The methods disclosed herein comprise one or more steps or actions for achieving the described method. The method steps and/or actions may be interchanged with one another without departing from the scope of the present invention. In other words, unless a specific order of steps or actions is required for proper operation of the embodiment, the order and/or use of specific steps and/or actions may be modified without departing from the scope of the present invention.

While specific embodiments and applications of the present invention have been illustrated and described, it is to be understood that the invention is not limited to the precise configuration and components disclosed herein. Various modifications, changes, and variations which will be apparent to those skilled in the art may be made in the arrangement, operation, and details of the methods and systems of the present invention disclosed herein without departing from the spirit and scope of the invention.

What is claimed is:

1. A method for coding medical data, the method comprising:
obtaining medical data;
determining, by a computing device, whether the medical data in a case matches a code or a code mapping;
coding, by the computing device, the case if the medical data matches a code, wherein coding comprises assigning a specific code to the case if the medical data matches the specific code; and
generating, by the computing device, a bill for the case based on the specific code if the medical data matches the specific code.

2. The method of claim 1, wherein if the medical data does not match a code:
obtaining coding for the medical data in a case;
determining whether the coding constitutes a new code mapping;
storing the code mapping if the coding constitutes a new code mapping;
coding the case; and
generating a bill for the case.

3. The method of claim 1, further comprising:
determining whether human interaction is required for a case;
coding the case if human interaction is not required; and
generating a bill for the case.

4. The method of claim 3, further comprising:
obtaining coding for the medical data in a case if human interaction is required;
determining whether the coding constitutes a new code mapping;
storing the code mapping if the coding constitutes a new code mapping;
coding the case; and
generating a bill for the case.

5. The method of claim 2, wherein obtaining coding for the medical data in a case comprises:
sending medical data; and
receiving a coding for the medical data.

6. The method of claim 5, further comprising:
generating suggested codes for the medical data; and
sending the suggested codes.

7. The method of claim 6, wherein the suggested codes are codes that have been previously used in cases containing similar medical data.

8. The method of claim 7, wherein the cases containing similar medical data are cases where a patient is the same.

9. The method of claim 1, further comprising:
extracting data elements from the medical data; and
storing the extracted data elements.

10. The method of claim 1, wherein the codes are International Classification of Diseases (ICD) codes and Current Procedural Terminology (CPT®) codes.

11. The method of claim 1, wherein generating a bill for the case comprises generating a bill to send to a recipient of medical services.

12. The method of claim 1, wherein generating a bill for the case comprises generating a bill to send to an insurance company of a recipient of medical services.

13. The method of claim 1, wherein generating a bill for the case comprises sending coded data to a billing system.

14. The method of claim 1, wherein obtaining medical data comprises obtaining medical data directly from one or more medical information systems.

15. The method of claim 14, wherein obtaining medical data comprises using a Dicom^{SM} worklist query on a PACS and a direct query on a RIS.

16. The method of claim 1, wherein obtaining medical data comprises obtain medical data from one or more medical information systems via an integrator.

17. The method of claim 1, wherein the medical data comprises order information and report information.

18. The method of claim 1, further comprising generating a list of cases that are not automatically coded or billed.

19. A computing device that is configured for coding medical data on a computing device comprising:
a processor;
memory in electronic communication with the processor;
instructions stored in the memory, the instructions being executable to:
obtain medical data;
determine whether the medical data in a case matches a code or a code mapping;
code the case if the medical data matches a code, wherein coding comprises assigning a specific code to the case if the medical data matches the specific code; and
generate a bill for the case based on the specific code if the medical data matches the specific code.

20. The computing device of claim 19, wherein if the medical data does not match a code, the instructions being further executable to:
obtain coding for the medical data in a case;
determine whether the coding constitutes a new code mapping;
store the code mapping if the coding constitutes a new code mapping;
code the case; and
generate a bill for the case.

21. The computing device of claim 19, the instructions being further executable to:
determine whether human interaction is required for a case;
code the case if human interaction is not required; and
generate a bill for the case.

22. The computing device of claim 21, the instructions being further executable to:
obtain coding for the medical data in a case if human interaction is required;
determine whether the coding constitutes a new code mapping;
store the code mapping if the coding constitutes a new code mapping;
code the case; and
generate a bill for the case.

23. The computing device of claim 20, wherein obtaining coding for the medical data in a case comprises:
sending medical data; and
receiving a coding for the medical data.

24. The computing device of claim 23, the instructions being further executable to:
generate suggested codes for the medical data; and
send the suggested codes.

25. The computing device of claim 24, wherein the suggested codes are codes that have been previously used in cases containing similar medical data.

26. The computing device of claim 25, wherein the cases containing similar medical data are cases where a patient is the same.

27. The computing device of claim 19, the instructions being further executable to:
extract data elements from the medical data; and
store the extracted data elements.

28. The computing device of claim 19, wherein the codes are International Classification of Diseases (ICD) codes and Current Procedural Terminology (CPT®) codes.

29. The computing device of claim 19, wherein generating a bill for the case comprises generating a bill to send to a recipient of medical services.

30. The computing device of claim 19, wherein generating a bill for the case comprises generating a bill to send to an insurance company of a recipient of medical services.

31. The computing device of claim 19, wherein generating a bill for the case comprises sending coded data to a billing system.

32. The computing device of claim 19, wherein obtaining medical data comprises obtaining medical data directly from one or more medical information systems.

33. The computing device of claim 32, wherein obtaining medical data comprises using a Dicom^{SM} worklist query on a PACS and a direct query on a RIS.

34. The computing device of claim 19, wherein obtaining medical data comprises obtaining medical data from one or more medical information systems via an integrator.

35. The computing device of claim 19, wherein the medical data comprises order information and report information.

36. The computing device of claim 19, the instructions being further executable to generate a list of cases that are not automatically coded or billed.

37. A tangible computer-readable storage medium for coding medical data on a computing device comprising executable instructions for:
obtaining medical data;
determining whether the medical data in a case matches a code or a code mapping;
coding the case if the medical data matches a code, wherein coding comprises assigning a specific code to the case if the medical data matches the specific code; and
generating a bill for the case based on the specific code if the medical data matches the specific code.

38. A method for integrating medical information systems, the method comprising:
obtaining medical data from one or more medical information systems;
storing or linking to the medical data in a database on a computing device;
integrating the medical data;
obtaining a syntax;
obtaining rules;
obtaining medical data from the database based on the syntax and the rules;
creating or linking tables in the database based on the syntax and the rules;
indexing the medical data in the database based on the syntax and the rules; and
outputting results by the computing device.

39. The method of claim 38, wherein outputting results comprises outputting work lists for further data collection.

40. The method of claim 38, further comprising assigning medical cases for peer review.

41. The method of claim 38, wherein the syntax comprises a field or subset of a field of medical data.

42. The method of claim 38, wherein the syntax comprises utilization codes.

43. The method of claim 38, wherein the rules comprise additional fields for data collection.

44. The method of claim 43, further comprising generating a data collection form based on the rules.

45. The method of claim 44, further comprising collecting additional data.

46. The method of claim 38, wherein the medical information systems comprise a Radiology Information System (RIS) and a Picture Archiving and Communication System (PACS).

47. The method of claim 38, further comprising determining a status based on the integrated medical data.

48. The method of claim 47, wherein the status is:
“ordered” if an order exists on one of the medical information systems, an image from one of the medical information systems is not associated with the order, and a report from one of the medical information systems is not associated with the order;
“no image” if an order exists on one of the medical information systems, an image from one of the medical information systems is not associated with the order, and a report from one of the medical information systems is associated with the order;
“undictated” if an order exists on one of the medical information systems, an image from one of the medical information systems is associated with the order, and a report from one of the medical information systems is not associated with the order; and
“finalized” if an order exists on one of the medical information systems, an image from one of the medical information systems is associated with the order, and a report from one of the medical information systems is associated with the order.

49. A method for transferring medical data, the method comprising:
receiving published medical data;
receiving group or user rights associated with the medical data;
receiving a request to download or view the medical data;
determining whether the request is authorized, wherein the request is authorized if user rights allow a requester to download or view the medical data or if the requester is a member of a group where the group rights allow the requester to download or view the medical data; and
transferring the medical data if the request is authorized and denying access if the request is not authorized.

50. The method of claim 49, wherein the medical data is published from a Dicom® source.

51. The method of claim 49, wherein the medical data is published from a non-Dicom® source.

52. The method of claim 49, wherein the medical data is published as a consultation request.

53. The method of claim 52, further comprising:
assigning a consultant;
notifying the consultant when the assignment is made; and
notifying a sender of the consulting request when a consultation report is created or modified.

54. The method of claim 53, wherein the consultant or sender is notified through an email.

55. The method of claim 49, wherein the medical data is published as a teaching file.

56. The method of claim 49, wherein the medical data is published to an archive.
